(19) United States
(12) Patent Application Publication
(10) Pub. No.: US 2008/0072225 A1
(43) Pub. Date: Mar. 20, 2008

(54) INFORMATION PROCESSING APPARATUS, INFORMATION PROCESSING METHOD, PROGRAM, AND RECORDING MEDIUM

(76) Inventors: Tetsuro NAGATSUKA, Kanagawa (JP); Eiji Kemmochi, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/857,045

(22) Filed: Sep. 18, 2007

(30) Foreign Application Priority Data
Sep. 19, 2006 (JP) 2006-252623
Sep. 18, 2007 (JP) 2007-240781

(51) Int. Cl. G06F 9/46

(52) U.S. Cl. 718/100

(57) ABSTRACT

An information processing apparatus capable of acquiring a user's document operation history and searching for a related document even when documents and information to be searched for are managed under plural and different systems and applications is disclosed, including a document operation event acquiring section acquiring the document operation event information representing the information related to an event of an document operation performed by a user on a client; a document operation event managing section managing the document operation event information acquired by the document operation event acquiring unit; and a task related document extracting section extracting a related document of a designated task based on the task information managed by the task information managing unit and the document operation event information managed by the document operation event managing unit.

### BACKGROUND OF THE INVENTION

1. Field of the Invention

The present invention generally relates to a method of extracting a related document based on a document operation history performed by a user on a computer and a method of extracting a task related document based on a document operation history when task information such as a schedule and a ToDo list is available.

2. Description of the Related Art

Recently, the overflow of information due to the widespread use of the Internet and the development of the digitized office environment has become a problem, and accordingly searching for necessary information and a document from a large amount of information has been required. As a conventional searching technique to meet the requirement, a keyword searching technique searching for a document by searching for a specific term in the document is known.

In addition, there is another technique called a related document search or a similar document search searching for a related document using a document as a key. In those techniques, the contents of a document are quantified based on a term included in the document and a degree of similarity is determined based on the data of the quantified document, thereby searching for a related document. Such a searching technique based on such information and the contents of the document may be very convenient. It is, however, necessary to acquire the contents of the document and information as the data to be used for searching, and accordingly the searching technique cannot be used for the document and information that cannot be acquired as data. Further, the association and similarity among documents used in the searching technique are based on the contents of the documents. Therefore, any document or information having the association or similarity but having different contents cannot be searched by using the above searching techniques.

Unlike the above searching technique based on the contents, there is another searching method searching for a related document based on the history of a user's operations performed on documents. In this method, the history of a user's operations on documents such as a viewing history is acquired and the related document is searched for based on the acquired operation history.

Further, there is known a document processing managing apparatus capable of automatically extracting a document having a high probability of being related to a document currently viewed based on the operation history performed by a user (see, for example, Patent Document 1). It should be noted that, in the Patent Document 1, the documents capable of being extracted are limited to the documents managed in the document processing managing apparatus.

Still further, as still another conventional technique, there is known a document searching method and a document searching apparatus capable of searching for a related job based on a document by acquiring the contents of jobs using a document, analyzing the types of the jobs, and managing the jobs using the documents without imposing an operational burden on a user (see, for example, Patent Document 2). In the Patent Document 2, the term job refers to a series of document operation events.

Still further, as still another conventional technique, there is a known method of accumulating a reference history by a user to a document in a document database and searching for a related document best related to a designated document based on, for example, the frequency of the reference history. (see, for example, Patent Document 3).

In above methods, a related document is extracted based on a user's search operations because it is assumed that “a user is likely to use a related document simultaneously with a high probability”. In such a method based on a document operation history, it is not necessary to acquire the contents of a document, and, advantageously, a related document can be extracted based on the document operations by a user in the jobs regardless of the contents of the document.
Patent Document 1: Japanese Patent Application and Publication No. 2003-85204
Patent Document 2: Japanese Patent Application and Publication No. HEI11(or 1999)-39293
Patent Document 3: Japanese Patent Application and Publication No. 2005-332326

However, in any of the above patents of Patent Documents 1 through 3, the target documents to be searched for are limited to the documents managed by each of the document managing units. Recently, however, it is taken for granted that a user uses various systems and applications to perform the jobs, therefore the information is often managed by separate systems. In such an environment, the above-mentioned methods can hardly provide sufficient effect as long as the methods can extract only the information and documents managed by a specific document management unit. Therefore, it is greatly desired to provide a method capable of searching for a related document from among the documents and information separately managed in plural systems and services.

### SUMMARY OF THE INVENTION

The present invention may provide a method capable of acquiring a document operation history performed by a user and searching for a related document using the information of the document operation history even when the documents and information are separately managed by plural systems and applications. The present invention may further provide a method capable of searching for a document and information related to a task by using the information of the document operation history when the task information such as a schedule and a ToDo list are managed.

According to one aspect of the present invention, there is provided an information processing apparatus including a document operation event acquiring unit acquiring the document operation event information representing the information related to an event of a document operation performed by a user on a computer; a document operation event managing unit managing the document operation event information acquired by the document operation event acquiring unit; and a related document extracting unit extracting a related document of a designated document based on the document operation event information managed by the document operation event managing unit.

By this configuration, the information of the document operation event performed by a user can be acquired and a related document can be searched for based on the acquired information regardless of, for example, the application, the document managing system, and the document format used by a user for document operations.

According to another aspect of the present invention, there is provided an information processing apparatus including a task information managing unit managing task information representing the information related to a user's task; a document operation event acquiring unit acquiring the document operation event information representing the information related to an event of a document operation performed by a user on a computer; a document operation event managing unit managing the document operation event information acquired by the document operation event acquiring unit; and a task related document extracting unit extracting a related document of a designated task based on the task information managed by the task information managing unit and the document operation event information managed by the document operation event managing unit.

By this configuration, the document operation event information performed by a user can be acquired and a related document can be searched for based on the acquired information regardless of, for example, the application, the document managing system, and the document format used by a user for document operations. Also, by using the time information of a task, it is possible to extract, for example, “a document used in a meeting” and search for a task related document based on a document operation event performed by a user.

According to still another aspect of the present invention, there is provided an information processing apparatus in which, when task related document information is managed by the task information managing unit, the task related document extracting unit extracts a related document of a designated task based on the task related document information and the document operation event information.

By this configuration, a task related document can be searched for based on a document operation event performed by a user from the information of the task related document having an explicit relationship.

According to still another aspect of the present invention, there is provided an information processing apparatus including a document operation event designating unit designating a document operation event used when a related document is extracted by the related document extracting unit.

By this configuration, a related document can be searched for by designating a type of operation event.

According to still another aspect of the present invention, there is provided an information processing apparatus including a document operation event designating unit designating a document operation event used when a related document is extracted by the task related document extracting unit.

By this configuration, a related document can be searched for by designating a type of operation event.

According to still another aspect of the present invention, there is provided an information processing apparatus including a user designating unit designating a user in which the related document extracting unit extracts a related document of a designated document based on the document operation event information of the user designated by the user designating unit from among the document operation event information managed by the document operation event managing unit.

By this configuration, it is possible to designate a related document extracting condition based on a “user” such as own document operation event information and other's document operation event information.

According to still another aspect of the present invention, there is provided an information processing apparatus including a user designating unit designating a user in which the task related document extracting unit extracts a task related document of a designated task based on the task information managed by the task information managing unit and the document operation event information of the user designated by the user designating unit from among the document operation event information managed by the document operation event managing unit.

By this configuration, it is possible to designate a related document extracting condition based on a “user” such as own document operation event information and other's document operation event information.

According to still another aspect of the present invention, there is provided an information processing apparatus in which the document operation event acquiring unit acquires at least one piece of information selected from the group consisting of the information of opening/closing, the information of focusing, and the information of copying/pasting as the document operation event information.

By this configuration, “a document simultaneously opened with a key document”, “a document viewed just before and after a key document is focused”, and “a document copied the information to a key document” can be searched for.

According to still another aspect of the present invention, there is provided an information processing method including a document operation event acquiring step of acquiring the document operation event information representing the information related to an event of an document operation performed by a user on a computer; a document operation event managing step of managing the document operation event information acquired in the document operation event acquiring step; and a related document extracting step of extracting a related document of a designated document based on the document operation event information managed in the document operation event managing step.

By this method, the information of the document operation event performed by a user can be acquired and a related document can be searched for based on the acquired information regardless of, for example, the application, the document managing system, and the document format used by a user for document operations.

According to still another aspect of the present invention, there is provided an information processing method including a task information managing step of managing task information representing the information related to a user's task; a document operation event acquiring step of acquiring the document operation event information representing the information related to an event of an document operation performed by a user on a computer; a document operation event managing step of managing the document operation event information acquired in the document operation event acquiring step; and a task related document extracting step of extracting a related document of a designated task based on the task information managed in the task information managing step and the document operation event information managed in the document operation event managing step.

By this method, the document operation event information performed by a user can be acquired, a related document can be searched based on the acquired information regardless of, for example, the application, the document managing system, and the document format used by a user for document operations. Also, by using the time information of a task, it is possible to extract, for example, “a document used in a meeting” and search for a task related document based on a document operation event performed by a user.

Further, each of the above-mentioned information processing methods may be performed by a computer by the use of a program, and the program may be stored in a computer-readable recording medium.

According to an embodiment of the present invention, the document operation history performed by a user can be acquired even when documents and information are managed under plural and different systems and applications, and by using the document operation history information, a related document can be searched for. Further, when task information such as a schedule and a Todo list are being managed, a document and information related to a task can be searched for using the document operation history information.

### BRIEF DESCRIPTION OF THE DRAWINGS

FIG. 1 is a block diagram showing an information processing system according to an embodiment of the present invention;

FIG. 2 is a block diagram showing a server according to a first embodiment of the present invention;

FIG. 3 is block diagram showing a client according to the first embodiment of the present invention;

FIG. 4 is a flowchart showing a process of the operations of an information processing system according to the first embodiment of the present invention;

FIG. 5 is a drawing showing an example of a user interface used for a user authentication;

FIG. 6 is a flowchart showing a document information event acquisition process according to the first embodiment of the present invention;

FIG. 7 is a flowchart showing a document information acquisition process according to the first embodiment of the present invention;

FIG. 8 is a diagram showing an example of acquiring the document information;

FIG. 9 is a flowchart showing an event registration process according to the first embodiment of the present invention;

FIG. 10 is a drawing showing an example of the open/close event information;

FIG. 11 is a drawing showing an example of the focus event information;

FIG. 12 is a drawing showing an example of the copy/paste event information;

FIG. 13 is a drawing showing an example of the copy original document information;

FIG. 14 is a flowchart showing a related document extraction process according to the first embodiment of the present invention;

FIG. 15 is a diagram showing an example of a related document extraction result;

FIG. 16 is a drawing showing an example of a related document extraction combination result;

FIG. 17 is a drawing showing an example of related document presentation;

FIG. 18 is a block diagram showing a server according to a second embodiment of the present invention;

FIG. 19 is a block diagram showing a client according to the second embodiment of the present invention;

FIG. 20 is a drawing showing an example of the task information;

FIG. 21 is a flowchart showing a task related document extraction process according to the second embodiment of the present invention;

FIG. 22 is a drawing showing an example of the task related document presentation;

FIG. 23 is a flowchart showing a modified example of the task document extraction process according to the second embodiment of the present invention;

FIG. 24 is a table showing the document operation event information, related to the opening/closing operations;

FIG. 25 is a table showing the document operation event information, related to the opening/closing operations;

FIG. 26 is a table showing the document operation event information, related to the focusing-start/focusing-end operations;

FIG. 27 is a table showing the document operation event information, related to the focusing-start/focusing-end operations;

FIG. 28 is a table showing the document operation event information, related to the copying/pasting operations;

FIG. 29 is a table showing the document operation event information, related to the copying/pasting operations;

FIG. 30 is a flowchart showing a process of acquiring the document operation event information;

FIG. 31 is a flowchart showing a process of acquiring the document operation event information when the document operation event is related to the opening/closing operation;

FIG. 32 is a flowchart showing a process of acquiring the document operation event information when the document operation event is related to the copying/pasting operation;

FIG. 33 is a flowchart showing a process of acquiring the document identification information;

FIG. 34 is a table showing the relationship between the applications and corresponding document location acquisition methods;

FIG. 35 is a table showing the relationship between the location types and the corresponding document contents acquisition methods;

FIG. 36 is a flowchart showing a process of the related document presentation executed by the related document presenting section;

FIG. 37 is a flowchart showing an extraction process when the related document extraction instruction includes the location information of the key document as the key document identification information;

FIG. 38 is a table showing examples of the held opening/closing related document information.

FIG. 39 is a table showing examples of the held focusing-start/focusing-end related document information;

FIG. 40 is a table showing examples of the held copy/paste times related document information;

FIG. 41 is a table showing examples of the same document information;

FIG. 42 is a flowchart showing a process of extracting a related document based on the related document extraction instruction executed by the related document extracting unit;

FIG. 43 is a presentation example of the related document of the related document displayed on the input/output section;

FIG. 44 is a block diagram showing an exemplary configuration of the client according to the fourth embodiment of the present invention;

FIG. 45 is a block diagram showing an exemplary configuration of the server according to the fourth embodiment of the present invention;

FIG. 46 is a table showing examples of schedule information;

FIG. 47 is a flowchart showing a process of acquiring the document operation event information executed by the document operation event acquiring section;

FIG. 48 is a table showing exemplary information samples of the document operation event information managed by the document operation event information managing section;

FIG. 49 is a table showing exemplary information samples of the document operation event information managed by the document operation event information managing section;

FIG. 50 is a flowchart showing a process of extracting the schedule related document executed by the schedule related document extracting section;

FIG. 51 is a table showing exemplary information samples of the document operation event information;

FIG. 52 is a flowchart showing a process of extracting the schedule related document executed by the schedule related document extracting section;

FIG. 53 is a table showing the acquired same document contents information;

FIG. 54 is a presentation example of the schedule related document displayed on the input/output section;

FIG. 55 is a block diagram showing a hardware configuration of an information processing apparatus capable of being used as the server and the client 30 according to one embodiment of the present invention;

FIG. 56 is a block diagram showing the functions performed by the server according to a third embodiment of the present invention;

FIG. 57 is a block diagram showing the function performed by the client according to the third embodiment of the present invention;

FIG. 58 is a flowchart showing the schedule related document presentation process executed by the schedule related document presenting section;

FIG. 59 is a flowchart showing a process of extracting the opening/closing operation related document information;

FIG. 60 is a flowchart showing a process of extracting the focusing-start/focusing-end operation related document information;

FIG. 61 is a flowchart showing a process of extracting the copying/pasting operation related document information;

FIG. 62 is a flowchart showing a process of extracting the opening/closing operation related document information;

FIG. 63 is a flowchart showing a process of extracting the focusing-start/focusing-end operation related document information;

FIG. 64 is a flowchart showing a process of extracting the copying/pasting operation related document information; and

FIG. 65 is a flowchart showing a process of extracting the schedule related document from the document operation event information DB.

### DETAILED DESCRIPTION OF THE PREFERRED EMBODIMENTS

In the following, an information processing system according to the embodiments of the present invention is described with reference to the accompanying drawings.

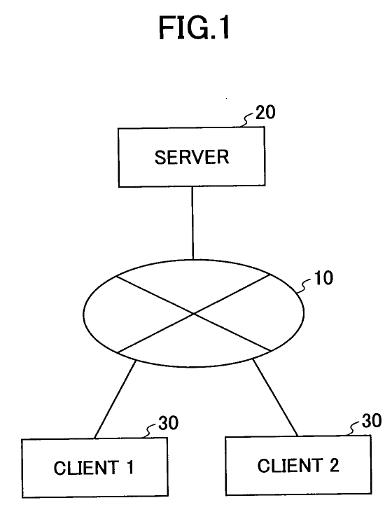

FIG. 1 is a block diagram showing an information processing system according to an embodiment of the present invention.

As shown in FIG. 1, an information processing system 1 includes one server 20, plural clients 30, and a network 10 providing connections among the server 10 and clients 30. There are two clients 30 drawn in this embodiment. But the number of the clients is not limited to two and may be one or more than two. It should be noted that the information processing apparatus 1 may also apply to a case where a whole system is provided as a single information processing apparatus.

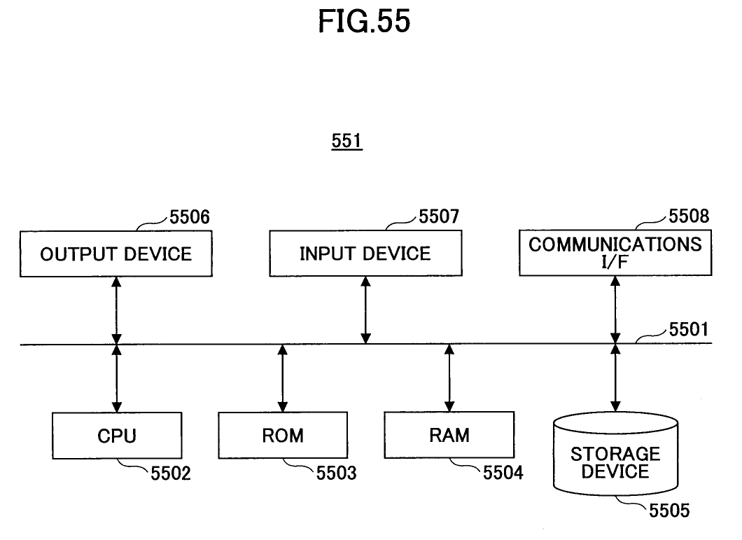

FIG. 55 shows a hardware configuration of an information processing apparatus 551 capable of being used as the server 20 and the client 30 according to one embodiment of the present invention. A CPU (Central Processing Unit) 5502, a ROM (Read Only Memory) 5503, a RAM (Random Access Memory) 5504, storage device 5505, an output device 5506, an input device 5507, and a communications I/F 5508 are connected to a bus 5501 of the information processing apparatus 551.

Details of the information processing apparatus are described. The CPU 5502, an example of a controlling unit, controls each device in the information processing apparatus 551 by executing a program stored in the ROM 5503. The RAM 5503 is used as a working area when the CPU 5502 executes the program and is also used as a storage unit to temporarily store the data generated in each process.

The storage device 5505 is a storage medium such a hard disk and stores the program executed by the CPU 5502 and the various data used in each process.

The output device 5506 may be, for example, a LCD (Liquid Crystal Display), a PDP (Plasma Display Panel), a PLD (Paper like Display) and displays various information when the information processing apparatus 551 is being operated. It should be noted that the output device 5506 is not limited to the above example and may be anything as long as it can display the various information.

The input device 5507 may be, for example, a button provided on the remote control device connected via wired or wireless connection to the chassis of the information processing apparatus 551 or the information processing apparatus 551. A user can input various data to the information processing apparatus 551 through the input device 5507. Or the output device may have a touch panel so as to work as an input device as well.

The communications I/F 5508 makes it possible to transmit the data provided from the CPU 5502 to the other information processing apparatus through a network such as the Internet and a LAN (Local Area Network) and to receive the data transmitted from the other information processing apparatus to provide the transmitted data to the CPU 5502. Further, the communications I/F 5508 according to an embodiment of the present invention is assumed to be able to work as an interface for connecting to an external device such as a digital camera, a scanner, and a printer. As the communications I/F 5508, not only a wired interface such as a USB but also a wireless interface such as the Bluetooth and the IrDA (Infrared Data Association) may be used. It should be noted that the server 30 and the client 20 according to an embodiment of the present invention are assumed to have the hardware configuration of the information processing apparatus 551. The output device 5506 and the input device 5507 are not essential elements and accordingly may not included in the server 20 and the client 30.

Further, in the embodiments below, explanations may be described based on an assumption that the target of a user's operations may be limited to a “document”. However, according to a basic technical concept of the present invention, the target of the user's operation is not limited to a “document” and may be various information including an image without any texts, mixed document including a text and an image, a moving picture, and a voice.

Therefore, in the descriptions of the embodiments of the present invention, it is assumed that the term “document” refers to various information including a text document consisting of texts, an image excluding texts, a mixed document including both texts and an image, a moving picture, and a voice.

### First Embodiment

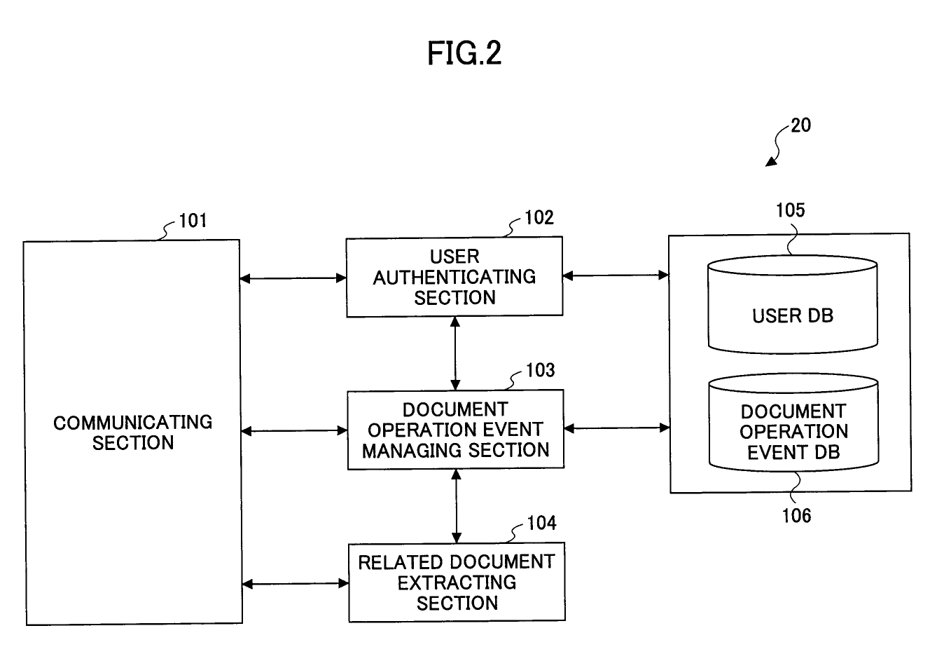

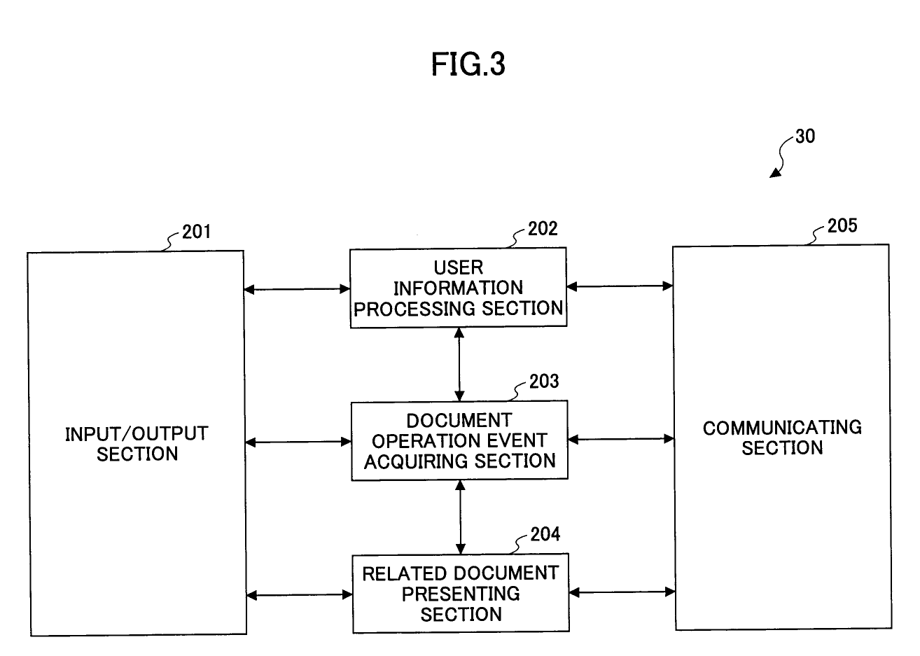

First, a first embodiment of the present invention is described. FIG. 2 is a block diagram showing a configuration of a server according to the first embodiment of the present invention. FIG. 3 is a block diagram showing a configuration of a client according to the first embodiment of the present invention.

As shown in FIG. 2, the server 20 includes a communicating section 101, a user authenticating section 102, a document operation event managing section 103, a related document extracting section 104, a user database 105, and a document operation event database 106.

The communicating section 101 corresponds to the communications I/F 5508 and provides data communications with the client 30.

The user authenticating section 102 performs a user authentication upon accepting a request from the client 30. The user authenticating section 102 performs the user authentication process by checking the user information (user name and password) transmitted from a user information processing section 202 described below.

The document operation event managing section 103 manages document operation event information. The document operation event managing section 103 manages the document operation event information, transmitted from a document operation event acquiring section 203 described below, in the document operation event database 106.

Here, the document operation event refers to an event of the document operation performed by a user using the client 30. In this embodiment, the document operation events refer to the events of opening/closing the document (opening/closing the document window), the focusing the document (set the document window to be the foreground window), and the copying/pasting a document (information is copied between the document windows via the clip board).

Further, the document operation event information refers to the information related to a document operation event. In this embodiment, the document operation event information includes the client identification information that is the information to identify the client 30 where the document operation event is performed, the operation target document information (a document title, a document identifier) that is the information related to the document of the performed document operation event, the application information that is the information related to the application where the document operation event is performed, an event name indicating the document operation event, the event execution time when the document operation event is performed, and the event unique information indicting the unique information of the document operation event.

The related document extracting section 104 extracts a document related to a designated document (hereinafter “a related document”) by using the document operation event information managed by the document operation event managing section 103.

Here, in this embodiment, the user authenticating section 102, the document operation event managing section 103, and the related document extracting section 104 may be, for example, a program executed by a CPU (Central Processing Unit) and stored in the storage device 5505 or a RAM 5504. The user database 105 and the document operation event database 106 may be, for example, a recording medium including a ROM (Read Only Memory), a RAM (Random Access Memory), and the storage device 5505.

Further, as shown in FIG. 3, the client 30 includes an input/output section 201, a user information processing section 202, a document operation event acquiring section 203, a related document presenting section 204, and a communicating section 205.

The input/output section 201 corresponds to the input device 5507 and receives, for example, the user information from a user.

The user information processing section 202 transmits the user information received by the input/output section 201 to the user authenticating section 102 to request a user authentication and receives the authentication result from the user authenticating section 102.

The document operation event acquiring section 203 acquires the document operation event information.

The related document presenting section 204 presents the searched result of the related document to a user. The related document presenting section 204 transmits the key document information used as a search key such as a currently viewed document or a user designated document (hereinafter “key document information”) to the related document extracting section 104 to request a related document searching process. Then the related document presenting section 204 receives the search result performed by the related document extracting section 104 and causes the input/output section 201 to output the result.

The communicating section 205 corresponds to the communication I/F 5508, and provides data communication with the server 20.

Here, in this embodiment, the input/output section 201 is realized by an input device 5507 such as a keyboard and a mouse and an output device 5506 such as a liquid crystal display. The user information processing section 202, the document operation event acquiring section 203, and the related document presenting section 204 are realized by, for example, a program executed by a CPU (Central Processing unit) and stored in the storage device 5505 and a RAM 5504.

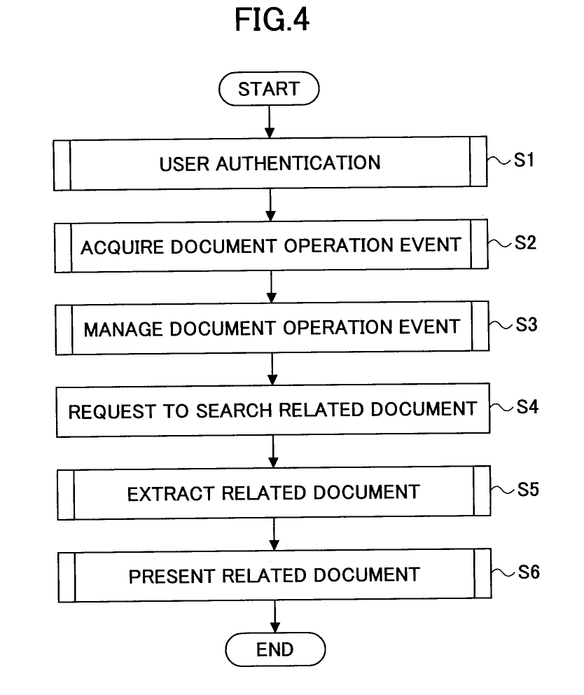

The operations of thus configured information processing system 1 are described with reference to FIG. 4. FIG. 4 is a flowchart illustrating the operations of an information processing system 1 according to the first embodiment of the present invention. The operations described below are realized when, for example, a computer program stored in the ROM 5503 and the storage device 5505 included in a server 20 or a client 30 is executed by the CPU 5502 included in the server 20 or the client 30, respectively. It should be noted that the computer program may be stored in a computer-readable recording medium other than the ROM 5503 and the storage device 5505. The computer-readable recording medium includes a magnetic recording medium, an optical recording medium, and a magneto-optical recoding medium.

First, a user is authenticated on the client 30 (step S1).

When the user authentication is successful, the document operation event acquiring section 203 starts acquiring the document operation event information (step S2). The document operation event acquiring section 203 transmits the acquired document operation event information to the document operation event managing section 103.

The document operation event managing section 103 stores the document operation event information transmitted by the document operation event acquiring section 203 in the document operation event database 106 (step S3).

The related document presenting section 204 transmits the key document information to the related document extracting section 104 to request a related document searching process (step S4).

The related document extracting section 104 extracts a related document from the document operation event information managed by the document operation event managing section 103 based on the key document information transmitted by the related document presenting section 204 (step S5). The related document extracting section 104 searches for, for example, “a document simultaneously opened with a designated document” based on the open/close event, a “document viewed before and after the designated document is viewed” based on the focus event, and a “document copied/pasted with the designated document” based on the copy/past event. Then the related document extracting section 104 extracts a related document by combining the search results. The related document extracting section 104 transmits the extracted information of the related documents (hereinafter “related document information”) as a related document search result to the related document presenting section 204.

The related document presenting section 204 presents the related document search result transmitted from the related document extracting section 104 to the user (step S6).

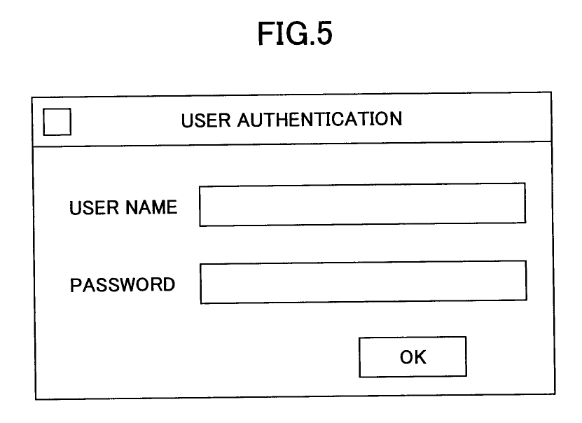

A detailed explanation of the above-mentioned operations is described with reference to FIGS. 5 through 18.

### [User Authentication]

First, a user is authenticated on a client 30. The user information processing section 202 displays the user information input user interface as shown in FIG. 5 on the input/output section 201 and prompts the user to input own user information (a user name and a password).

The user information processing section 202 transmits the input user information (the user name and the password) through the input/output section 201 to the user authenticating section 102. The user authenticating section 102 acquires the user information from the user database where the user information is previously registered, compares the user information with the user information transmitted from the user information processing section 202, and returns the result whether the user authentication is successful to the user information processing section 202.

When the user authentication is successful, the user information processing section 202 holds the user information. Otherwise, the user information processing section 202 causes the input/output section 201 to display the user information user interface to prompt the user to input the user information (a user name and a password). It should be noted that the user authentication may be performed by acquiring the user ID (user name) and the password input when the user logs in the OS during the process of starting up the client 30. In this case, when the user authentication is successful, it is assumed that the status that the user is being authenticated is maintained until the user logs off the OS.

### [Document Operation Event Acquisition]

The document operation event acquiring section 203 acquires the document operation event information. In this embodiment, it is assumed that an OS (Operating System) having a window system as a GUI (Graphic User Interface) such as Microsoft Windows (Trademark) as an example is running on the client 30.

Further, in this embodiment, it is assumed that the document event acquiring section 203 acquires a user name, a client identifier, an application name, a document title, a document identifier, an event name, the execution time, and the event unique information as the document operation event information.

The user name refers to a user ID held by the user information processing section 202 upon the user authentication.

The client identifier is used to identify the client 30, therefore, for example, the IP address or the MAC address of the network device may be used. In this embodiment, it is assumed that the IP address is used.

The application name refers to the application name used when a user operates on a document. In this embodiment, the file name of the execution module of the application is used.

The document title refers to the title of the document, but the title of the displayed window or file name may also be used as the document title.

The document identifier refers to the ID capable of uniquely identifying the document. Any information capable of uniquely identifying the document may be used. In this embodiment, the information indicating the storage location of the document such as the URL of the Web document, the file path of the file managed by a file system, the DB server name of the document managed by the DB, the DB name, and the document ID is used.

The event name is used to identify the event. In this embodiment, the events have three types: that is, “open/close” event, “focus-start/focus-end” event, and “copy/paste” event. Any one of the above events is acquired as the event name.

The execution time is the time when an event is executed. In this embodiment, when the “open/close” event is selected, the event acquiring section 203 acquires the time when a document window is opened and closed as the start time and end time, respectively; when the “focus-start/focus-end” event is selected, the event acquiring section 203 acquires the time when a document window is set to be a foreground window and the time when the foreground window is ended as the start time and the end time; when the “copy/paste” event is selected, the event acquiring section 203 acquires the time when the paste operation is performed.

The event unique information refers to the information unique to the event. However, in this embodiment, the document operation event acquiring section 203 acquires only the copy original document information upon the “copy/paste” event.

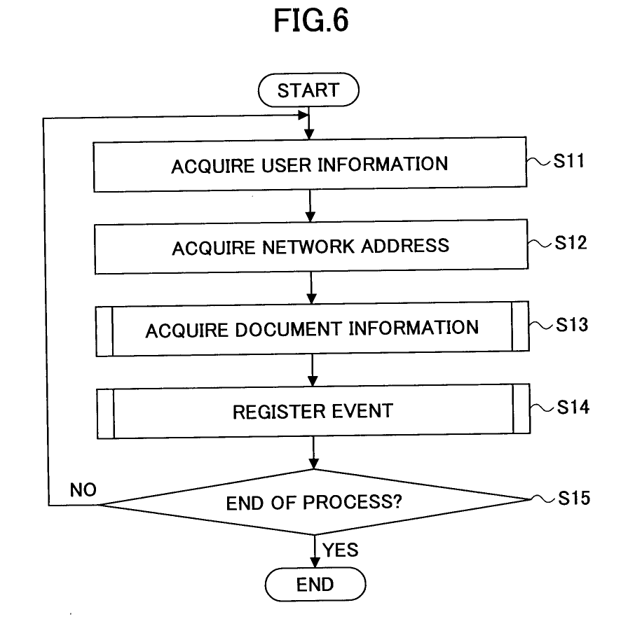

Next, a detail of the document operation event acquisition process is described. FIG. 6 is a flowchart showing the document operation event acquisition process according to the first embodiment of the present invention.

In the user information acquisition process, the document operation event acquiring section 203 acquires the user ID from the user information processing section 202 (step S11).

In the network address acquiring process, the document operation event acquiring section 203 acquires the IP address (step S12).

In the document information acquisition process, the document operation event acquiring section 203 acquires the information of the currently viewed document (that is, the document window is set to be the foreground (focused) window) (step S13). It should be noted that in the document information acquisition process, the information of all windows currently opened is acquired.

In the event registration process, the document operation event acquiring section 203 checks whether an event has occurred and, when necessary, transmits the event information as the document operation event information to the document operation event managing section 103 (step S14).

The document operation event acquiring section 203 determines whether an instruction to end the process is present (step S15). When there is no instruction to end the process, the document operation event acquiring section 203 repeats a series of processes (steps S11 through S14). To reduce the burden of the process, a wait time may be set when the processes are repeated.

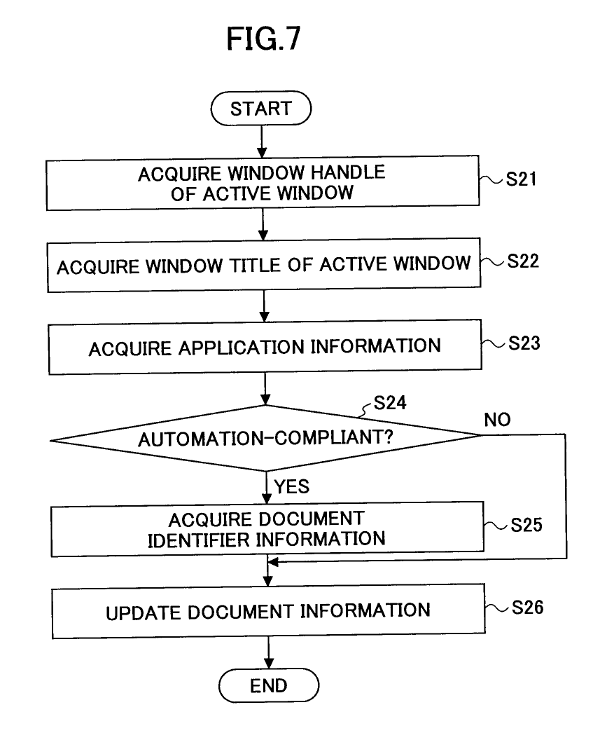

Next, a detail of the document information acquisition process (step S13) is described. FIG. 7 is a flowchart of the document information acquisition process according to the first embodiment of the present invention. In the following, the document operation event acquisition method is described, assuming that, for example, a computer with Microsoft Windows (Trademark) installed is used.

In the Windows system, a document is displayed within an area called window, and a user can operate while switching windows (changing the foreground window). When Microsoft Windows (Trademark) is used, there is provided a technique called Automation by which the internal object and the functions of the Automation-compliant application and the service can be disclosed to an external application or service. When the application is Automation-compliant, the document identifier can be acquired in most cases. Therefore, in this embodiment, it is assumed that the document operation event acquiring section 203 acquires the document title and application name of all the documents and also acquires the document identifier from a document displayed by the Automation-compliant application.

First, the document operation event acquiring section 203 acquires the window handle of an active window as the window handle so as to acquire the information of the document display window (step S21). It is possible to acquire the window handle of the window currently activated when an API called “GetActiveWindow( )”, one of the APIs called Win32API, is used.

Next, the document operation event acquiring section 203 acquires the window title of the active window using the acquired window handle, and regards the window title as the document title (step S22). In this process, other information such as application name may be input into the window title. But, in this embodiment, even in such a case, the window title is regarded as a document title. Here, the window title can be acquired by using the API called “GetWindowText( )”.

Next, the document operation event acquiring section 203 acquires the application information displaying the document (step S23). Here, when an API called “GetWindowThreadProcessld( )” is used, the file name and the path name of the module executing the window can be acquired through the window handle. By this manner, the application displaying the document can be identified.

Next, the document operation event acquiring section 203 determines whether the application displaying the documents is Automation-compliant (step S24). The document operation event acquiring section 203 previously creates an Automation-compliant application execution file list and determines whether the application is Automation-compliant by comparing the file name of the module of the application with the list.

When it is determined that the application is Automation-compliant, the document operation event acquiring section 203 acquires the document identifier corresponding to each of such applications, and when no data corresponding to such information can be acquired from the application, no information is input as the data (step S25). On the other hand, when it is determined that the application is not Automation-compliant, no document identifier is input as the data and the process goes to step S26.

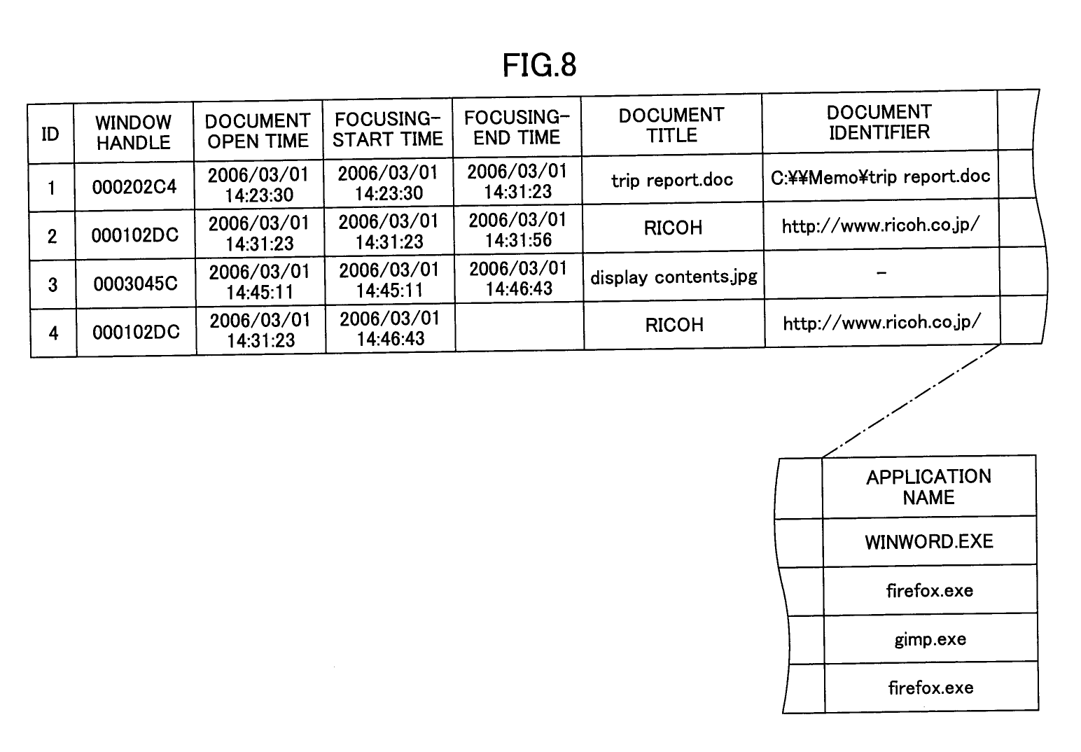

Next, the document operation event acquiring section 203 updates the document information (step S26). FIG. 8 shows an example of the acquired document information. The document information acquired by the document operation event acquiring section 203 is managed in the format shown in FIG. 8. Here, in addition to the information of the currently viewed document, a past viewed history is also stored.

In the document information update process, the document operation event acquiring section 203 determines whether a viewed document is switched over. When the viewed document is switched over, the document operation event acquiring section 203 updates the document information. In the document information record, the currently viewed document has the greatest ID number (there are no data of the focus end time) (see, for example, the document of ID 4 in FIG. 8). When any information of the “window handle”, the “document title”, and the “document identifier” of the acquired document is different from the corresponding information of the currently viewed document, the document operation event acquiring section 203 determines that the viewed document is switched over, registers the current time as the focus end time of the currently viewed document information (ID 4) in the document information record, and registers the acquired information as the new document information (ID 5). Then the document operation event acquiring section 203 registers the current time as the “focus start time” of the new document information. In this case, when any of the “window handle”, “document title”, or “document identifier” of the new document information is already included as the data in the document information record, the document operation event acquiring section 203 registers the “document open time” of the data in the document information record as the “document open time” of the new document information. Otherwise the document operation event acquiring section 203 registers the current time as the “document open time” of the new document information.

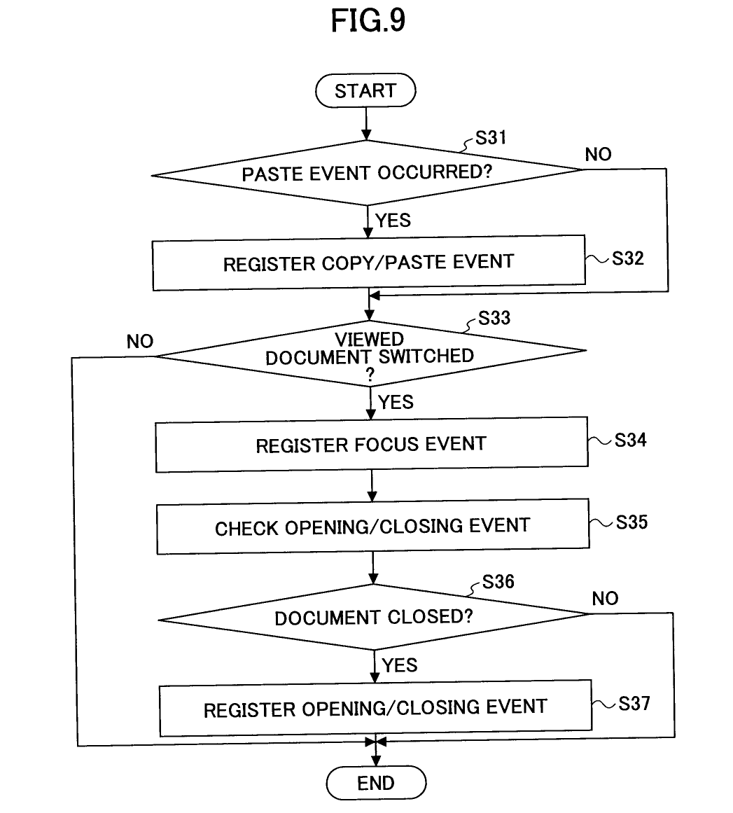

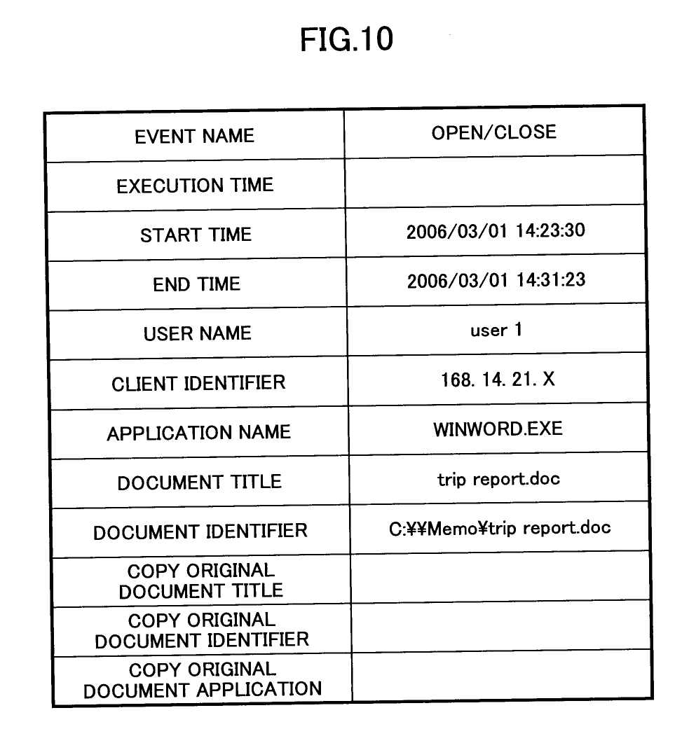

Next, a detail of the event registration process (step S14) is described. FIG. 9 is a flowchart showing the event registration process according to the first embodiment of the present invention. FIGS. 10, 11, and 12 show examples of the “open/close”, “focus-start/focus-end”, and “copy/paste” events information, respectively.

In the event registration process, the document operation event acquiring section 203 checks whether an event has occurred. When an event has occurred, the document operation event acquiring section 203 transmits the event information as the document operation event information to the document operation event managing section 103. In the following, each process when each of the events has occurred is described.

First, the copy/paste event information is registered when a paste event has occurred. The check whether the copy/paste event has occurred is performed by monitoring the data on the clipboard and the key input. In Microsoft Windows (Trademark) environment, the data change on the clipboard can be acquired when an API called “SetClipboardViewer( )” is used.

When a data change has occurred in the clipboard, the document operation event acquiring section 203 checks the clipboard information and acquires the window handle of the copy original. Then the document operation event acquiring section 203 acquires the “document title”, the “document identifier”, and the “application name” through the window handle of the copy original using the same process as the above-mentioned document information acquisition process and stores the acquired information as the copy original document information. Here, FIG. 13 shows an example of the copy original document information. Since the paste operation is performed when Ctrl key and V key are used, the document operation event acquiring section 203 determines whether a paste event has occurred by acquiring the message of the key inputs (step S31).

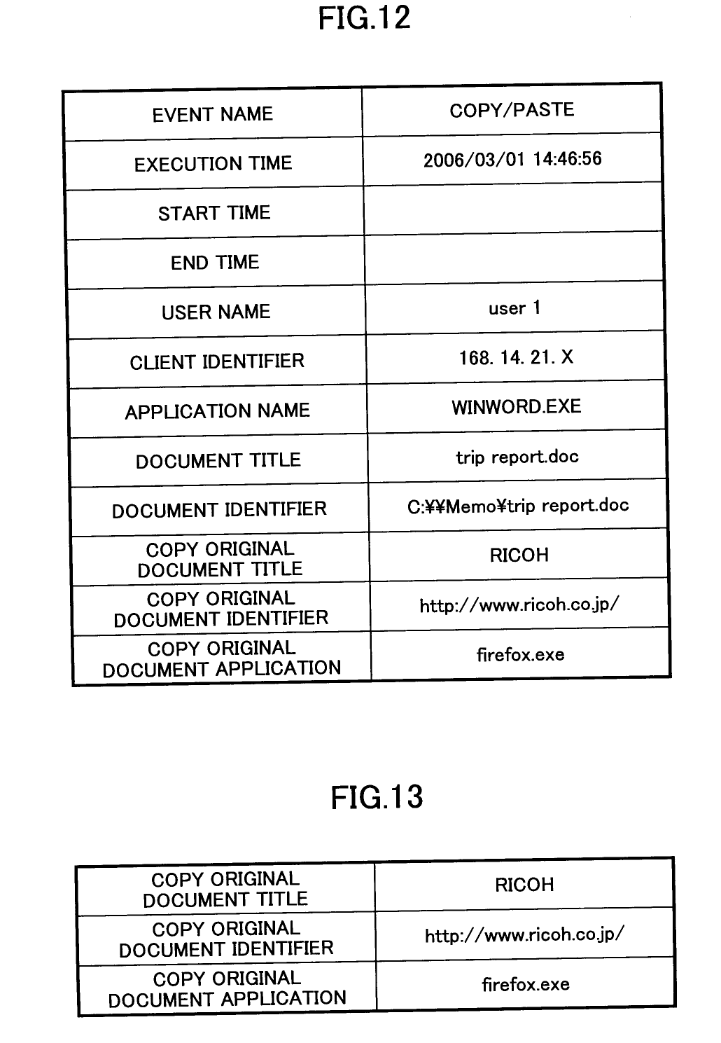

When it is determined that a paste event has occurred, the document operation event acquiring section 203 acquires the document information of the currently viewed document from the document information record, creates the copy-paste event information as shown in FIG. 12 by adding the user information, the client identifier, the event occurrence time (current time), and the copy original document information to the acquired document information as the copy-paste event information, and transmits the copy/paste event information to the document operation event managing section 103 to register the copy/paste event information (step S32). On the other hand, when it is determined that a paste event has not occurred, the process goes to step S33.

Next, the focus event information is registered when a viewed document is switched over. The document operation event acquiring section 203 determines whether a viewed document is switched over in the document information acquisition process (step S33).

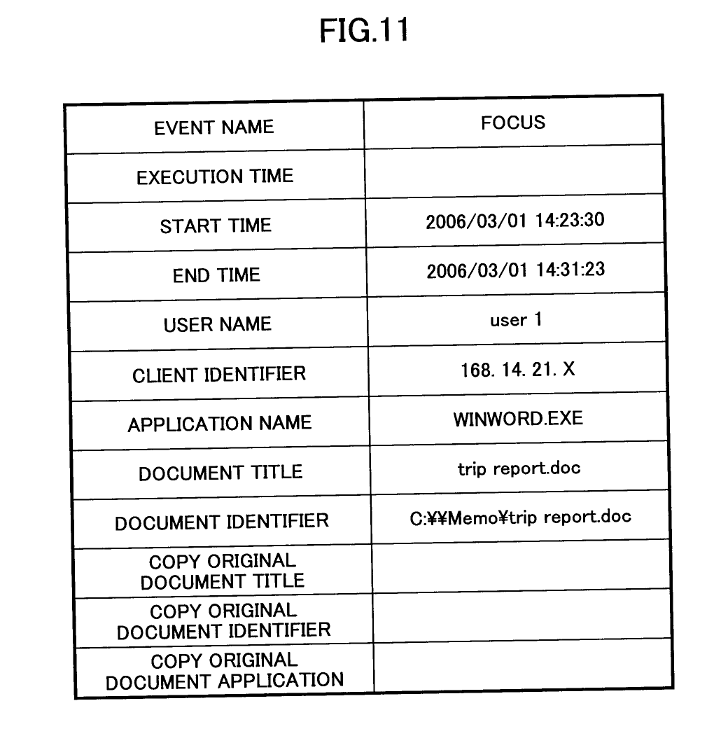

When it is determined that the viewed document is switched over, the document operation event acquiring section 203 acquires the document information of the document focused until just before the switching, creates the focus event information as shown in FIG. 11, and transmits the focus event information to the document operation event managing section 103 to register the focus event information (step S34). On the other hand, when it is determined that a viewed document is not switched over, this process ends.

The open/close event is registered in a case where, when a viewed document is switched over, either the window of the document focused on until just before the switching is closed or a new document is newly viewed in the same window. When a viewed document is switched over in the document information acquisition process, the document operation event acquiring section 203 acquires the document information of the document focused on until just before the switching and checks whether the window is closed or a new document is newly viewed in the same window by checking the window handle information (step S35).

The document operation event acquiring section 203 determines whether the document is closed (step S36). Here, it is assumed that whether the document is closed is determined by checking whether the window is closed or a new document is newly viewed in the same window.

When it is determined that the document is closed, the document operation event acquiring section 203 creates the open/close event information as shown in FIG. 10, transmits the open/close event information to the document operation event managing section 103 to register the open/close event information (step S37). When the open/close event is registered, the registered document information is deleted from the document information record shown in FIG. 8. On the other hand, when it is determined that the document is not closed, the process ends. By the above processes, the document operation event information is acquired and registered.

### [Document Operation Event Management]

The document operation event acquiring section 103 records the document operation event information, transmitted from the document operation event acquiring section 203, in the document operation event database 106. The items of the database are the same as the items of the each event information of the open/close event information, the focus-start/focus-end event information, and the copy/paste event information as shown in FIGS. 10, 11, and 12, respectively. The document operation event managing section 103 records the information shown in the FIGS. 10, 11, and 12 in the document operation event database 106.

### [Related Document Extraction]

The related document extracting section 104 extracts a related document based on the extraction instruction transmitted from the related document presenting section 204 and transmits the extracted related document as a search result to the related document presenting section 204. The key document identifier information including the document identifier of the key document is transmitted as the key document information from the related document presenting section 204. When the related document extracting section 104 receives the extraction instruction from the related document presenting section 204, the related document extracting section 104 searches the related document with respect to each document operation event type by way of the document operation event managing section 103 by using the key document identifier information.

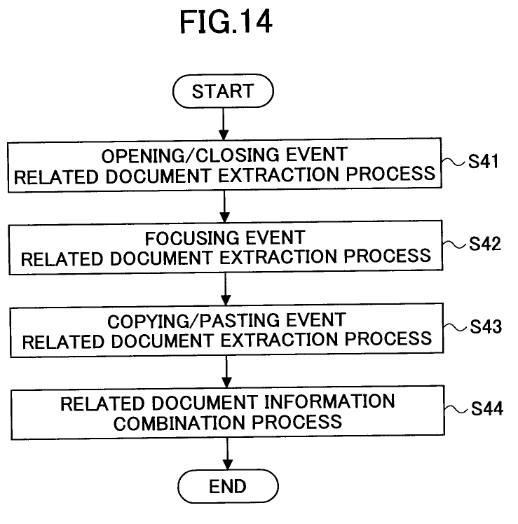

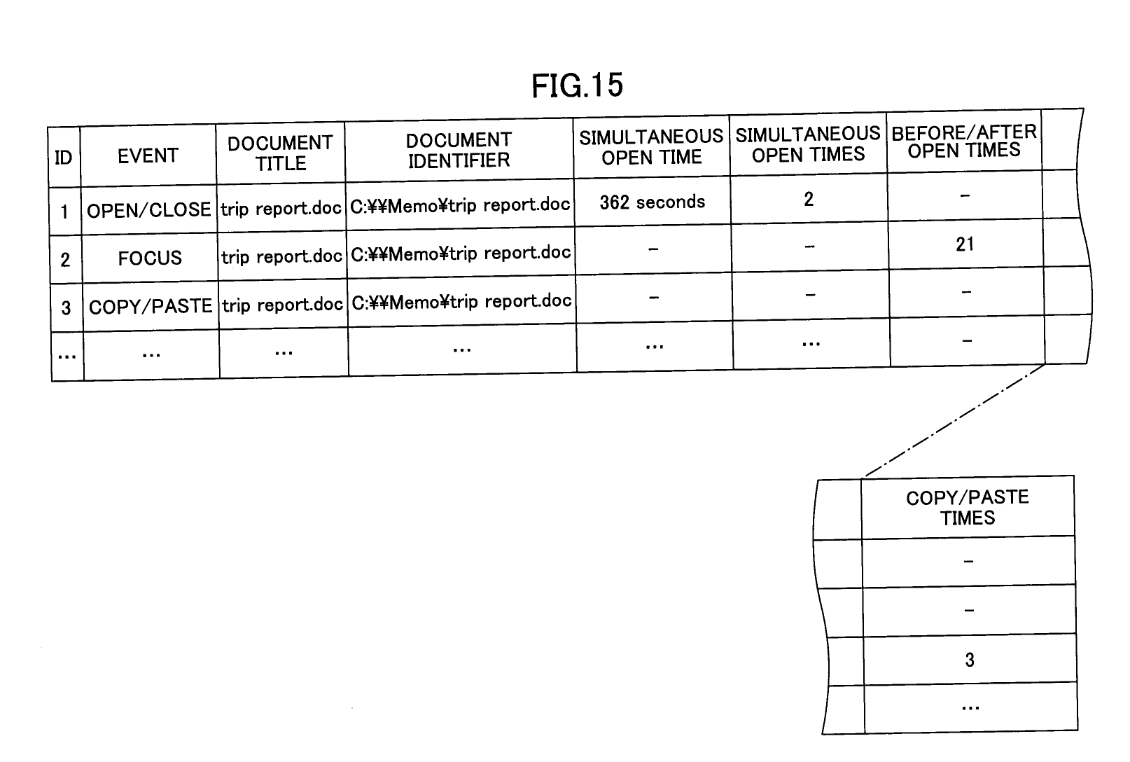

FIG. 14 is a flowchart of the related document extraction process according to the first embodiment of the present invention. FIG. 15 shows an example of the related document extraction result.

First, the related document extracting section 104 performs an open/close event related document extraction (step S41). In a case of the “open/close” event, the related document extracting section 104 extracts a related document simultaneously opened with the key document from the document operation event history in the document operation event database managed by the document operation event managing section 103 by setting the following conditions: the event type is the open/close event; and the document identifier is the same document identifier of the key document and the “start time” and “end time” are checked with those of the key document to search a document opened simultaneously with the key document.

Based on the document operation event history, an example of the search formula used by the related document extracting section 104 to search a related document on the conditions: the event type is open/close event; and the document identifier is the same as the document identifier of the key document is given as formula 1 below, and an example of the search formula to search a related document opened with the key document by checking the overlap of “start time” and “end time” is given as formula 2 below:

### (Formula 1)

Select*from “document operation event DB” where “event” =“open/close” and “document identifier” =“document identifier of key document” (1)

### (Formula 2)

Select*from “document operation event DB” where “event”=“open/close” and “document identifier”=“document identifier of key document” and (“start time”>=“start time of key document” and “end time”>“start time of key document”) or (“start time”>=“end time of key document” and “end time”>“end time of key document”) (2)

The related document extracting section 104 records the search result as the related document extraction result as shown in FIG. 15 (see the example of ID 1 in FIG. 15). Here, when the information of the same event and the same document identifier are already recorded, the related document extracting section 104 updates the information by summing up the time period when the document is simultaneously opened (simultaneous open time) and the times that the document is simultaneously opened (simultaneous open times).

Next, the related document extracting section 104 performs a focus event related document extraction process (step S42). In a case of the “focus” event, the related document extracting section 104 extracts a related document focused on just before or after the key document is focused on based on the document operation event history from among the documents where the event type is the focus event and the document identifier is the same as the document identifier of the key document.

Based on the document operation event history, an example of the search formula used by the related document extracting section 104 to search for a related document on the conditions: the event type is focus event; and the document identifier is the same as the document identifier of the key document is given as formula 3 below, and an example of the search formula to search a related document focused just before or after the key document is focused on by checking before and after the “start time” and “end time” is given as formula 4 blow:

### (Formula 3)

Select*from “document operation event DB” where “event”=“focus” and “document identifier”=“document identifier of key document” (3)

### (Formula 4)

Select*from “document operation event DB” where “event”=“focus” and “document identifier”=“document identifier of key document” and (“start time”>=“end time of key document” and “start time”<“end time of key document+5 seconds”) or (“end time”<=“start time of key document” and “end time”>=“start time of key document−5 seconds”) (4)

Here, the document starts being focused on within 5 seconds after the focus end time of the key document is assumed to be a document focused on just after the key document is switched over, and the document ends focused within 5 seconds before the focus start time of the key document is assumed to be a document focused on just before the key document is switched over.

The related document extracting section 104 records the search result as the related document extraction result as shown in FIG. 15 (see an example of ID 2 in FIG. 15). Here, when there is already the information having the same event or the same document identifier, the related document extracting section 104 updates the information by summing up the before and after focused times.

Next, the related document extracting section 104 performs a copy/paste event related document extraction process (step S43). In a case of the “copy/paste” event, the related document extracting section 104 extracts a document operation event where the event type is the copy/paste event, the document identifier is the same as the document identifier of the key document based on the document operation event history, and where the event type is the copy/paste event and the document identifier of the copy original is the same as the document identifier of the key document based on the document operation event history.

Based on the document operation event history, an example of the search formula, used by the related document extracting section 104, to search for a related document where the event type is copy/paste event and the document identifier is the same as the document identifier of the key document is given as formula 5 below. Based on the document operation event history, an example of the search formula, used by the related document extracting section 104, to search for a related document where the event type is copy/paste event and the document identifier of the copy original is the same as the document identifier of the key document is given as formula 6 below.

### (Formula 5)

Select*from “document operation event DB” where “event”=“copy/paste” and “document identifier”=“document identifier of key document” (5)

### (Formula 6 )

Select*from “document operation event DB” where “event”=“copy/paste” and “document identifier of the copy original”=“document identifier of key document” (6)

In a case of formula (5), the document title of the copy original and the document identifier of the copy original of the document operation event of the search result are recorded as the related document information. In a case of formula (6), the document title and the document identifier are recorded as the related document information. The related document extracting section 104 records those searching result as the related document extraction result as shown in FIG. 15 (see an example of ID3 in FIG. 15). Here, when there is already the information recorded having the same event or the same document identifier, the related document extracting section 104 updates the information by summing up the copy/paste times.

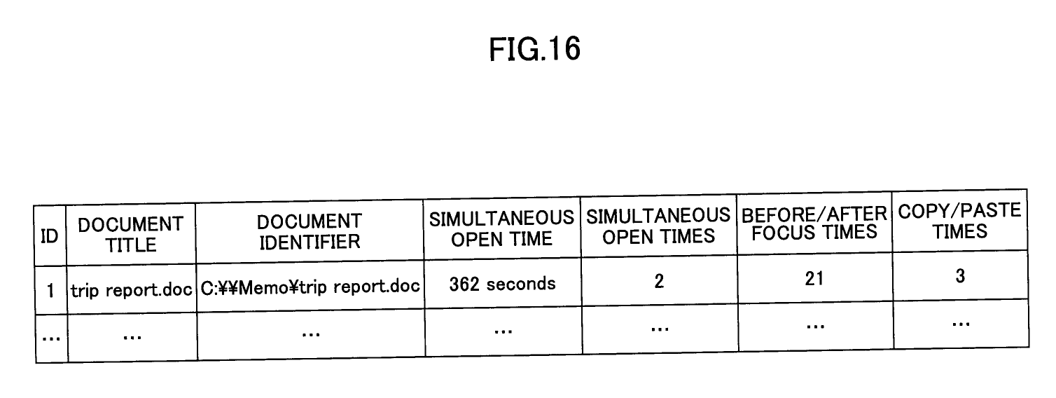

Last, the related document extracting section 104 performs a related document information combination process (step S44). In the related document information combination process, the related document extracting section 104 combines the related document extractions results shown in FIG. 15 to create a combination result where all data have the same document identifier as shown in FIG. 16. Then, the related document extracting section 104 transmits the related document extraction combination result information as shown in FIG. 16 to the related document presenting section 204.

### [Related Document Presentation]

The related document presenting section 204 presents the related document. The related document presenting section 204 sends a request to search for the related document of the currently viewed document to the related document extracting section 104, and causes the input/output section 201 to display the searched related document. Further, the related document presenting section 204 may be arranged to cause the input/output section 201 to display the currently viewed document to prompt a user to designate the key document and may send a request to search for the related document of the designated key document to the related document extracting section 104 and cause the input/output section 201 to display the searched related document.

Further, the related document presenting section 204 may be arranged to prompt a user to input an arbitrary document identifier through the input/output section 201 and to send a request to search for a related document using the input document identifier as a key document identifier to the related document extracting section 104 and to cause the input/output section 201 to display the searched related document. Here, the information of the currently viewed (focused) or the currently opened document can be acquired through the document operation event acquiring section 203 (see document information shown in FIG. 8).

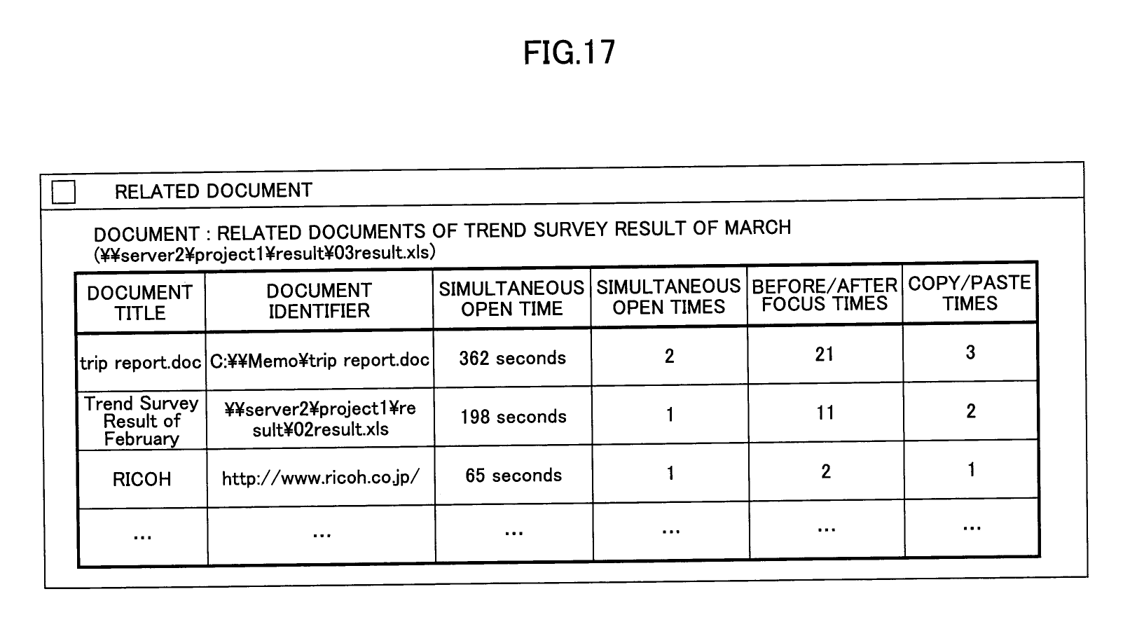

FIG. 17 shows an example of the related document presentation. In this example, a user can sort the related document search result by selecting the item and select the displayed document title or document identifier to open the document through the input/output section 201.

The information processing system 1 according to the first embodiment of the present invention can acquire the document operation event performed by a user and search for the related document based on the event regardless of, for example, the application and document management system used by a user for document operation and the document format.

Though, in this embodiment, the relative document extraction process is performed based on three document operation events, the open/close event, the focus-start/focus-end event, and the copy/paste event, the embodiments of the present invention are not limited to this embodiment and, for example, a user may designate a document operation event through the input/output section 201 and the related document extraction process may be performed based on the designated document operation event.

To perform the related document extraction process in the above manner, the user designates a “usage document operation event” in addition to the key document identifier when requesting the related document extraction process from the related document presenting section 204 of the client 30. When the usage document operation event is designated, only the corresponding document operation event in the flow (related document extraction process) shown in FIG. 14 is performed. When the usage document operation event is not designated, all the document operation events are performed.

By this configuration, a related document can be searched for by designating a type of operation event.

Further, in this embodiment of the present invention, though the related document extracting section 104 extracts the related document of the designated document based on the document operation events of all users, the present invention is not limited to the embodiment and, for example, a user may designate a specific user through the input/output section 201 and the related document of the designated document may be extracted based on the document operation event of the designated user.

To perform the related document extraction process in the above manner, the user designates a “usage user” in addition to the key document identifier when requesting the related document extraction process from the related document presenting section 204 of the client 30. When the usage user is designated, a user designation condition is added to the search formula for the related document extraction process of each event. When use user is not designated, all the document operation events may be used, or only the document operation events performed by the current user may be used.

Here, each search formula in modified example in a case where usage user is designated is shown below. The above-mentioned formulas (1), (3), (5), and (6) are modified as given in formulas (7), (8), (9), and (10), respectively.

### (Formula 7)

Select*from “document operation event DB” where “event”=“open/close” and “document identifier”=“document identifier of key document” and “user name”=“designated user name” (7)

### (Formula 8)

Select*from “document operation event DB” where “event”=“focus” and “document identifier”=“document identifier of key document” and “user name”=“designated user name” (8)

### (Formula 9)

Select*from “document operation event DB” where “event”=“copy/paste” and “document identifier”=“document identifier of key document” and “user name”=“designated user name” (9)

### (Formula 10)

Select*from “document operation event DB” where “event”=“copy/paste” and “document identifier of the copy original”=“document identifier of key document” and “user name”=“designated user name” (10)

By using this, the relative document extraction condition can be designated using a “user” as a key based on, for example, own document operation event information and other's document operation event information only.

Further, in this embodiment of the present invention, though the client 30 includes the user information processing section 202, the document operation event acquiring section 203, and the related document presenting section 204, the present invention is not limited to this configuration, and, for example, the server 20 may include one or more sections selected from among the user information processing section 202, the document operation event acquiring section 203, and the related document presenting section 204.

### Second Embodiment

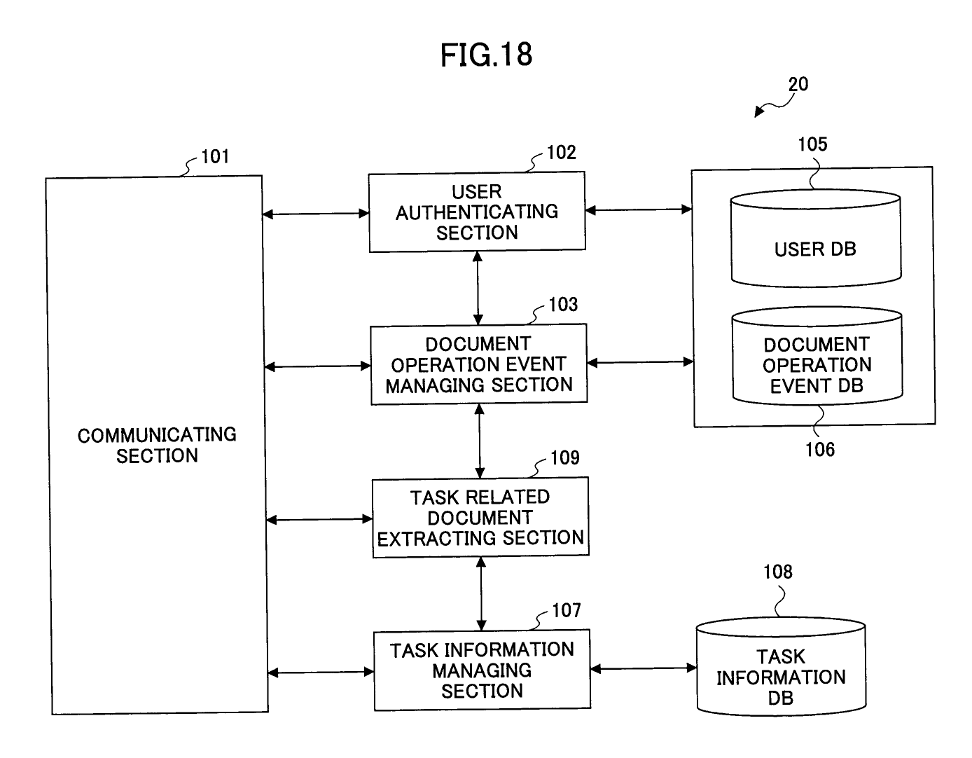

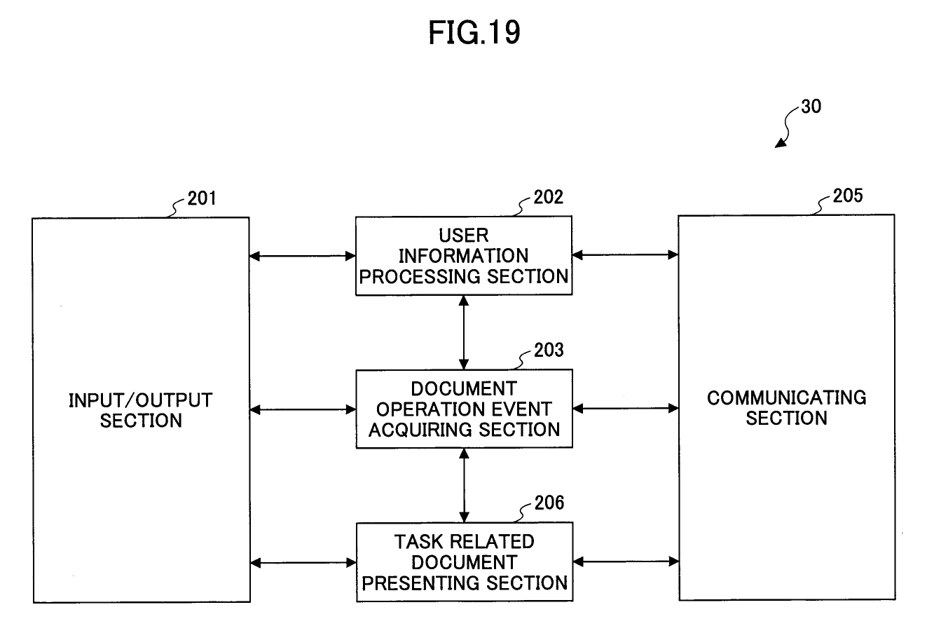

Next, a second embodiment of the present invention is described. FIGS. 18 and 19 are block diagrams showing the configurations of a server and a client, respectively, according to the second embodiment of the present invention.

The same reference numerals for the elements of the server and the client in the first embodiment of the present invention are commonly used in the same elements of the server and the client in the second embodiment of the present invention and the descriptions of such same reference numerals are omitted herein.

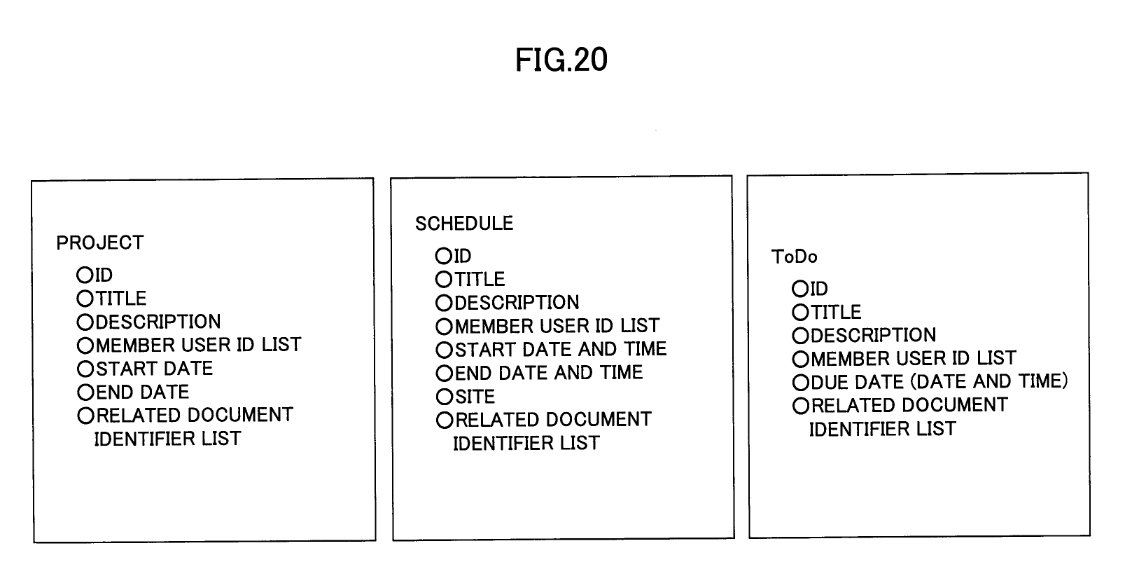

A task information managing section 107 manages the task information representing the information related to a user's task. In this embodiment, the task information managing section 107 manages the information related to a project, a schedule, and a Todo task as the task information. Here, samples of the task information are shown in FIG. 20. The task information managing section 107 stores the information of the ID, the title, the description, the member user ID list, the start date, the end date, and the related document identifier list regarding the project task; the information of the ID, the title, the description, the member user ID list, the start date and time, the end date and time, the place, and the related document identifier list regarding the schedule task; and the information of the ID, the title, the description, the member user ID list, the due date (date and time), and the related document identifier list regarding the Todo task in the task information database 108.

The related document identifier list refers to the information of the document related to a task as the related document by a user.

A task related document extracting section 109 extracts a document related to the designated task (hereinafter “task related document”) based on the task information managed by the task information managing section 107 and the document operation event information managed by the document operation event managing section 103.

A task related document presenting section 206 presents the search result of the task related document. The task related document presenting section 206 transmits the information of the key task used as a search key such as currently displaying task or the task designated by a user (hereinafter “key task information”) and the key document information to the task related document extracting section 109 and requests to perform the task related document search process. Then the task related document presenting section 206 receives the search result from the task related document extracting section 109 and causes the input/output section 201 to output the result.

Here, in this embodiment, the task information managing section 107, the task related document extracting section 109, and the task related document presenting section 206 is realized by, for example, a program executed by the CPU (Central Processing Unit) 5502 of each information processing apparatus and stored in the storage device 5505 or a RAM 5504. The task information database 108 is realized by a storage medium such as the ROM (Read Only Memory) 5503, the RAM (Random Access Memory) 5504, and the storage device 5505.

The operations in thus configured information processing system 1 are described below. It should be noted that only the explanations where the operations are different from those in the first embodiment are described. Further, in this embodiment, the task related document extraction process is performed instead of performing the related document extracting process shown in FIG. 4.

### [Task Related Document Extraction]

The task related document extracting section 109 extracts a task related document based on the extraction instruction transmitted from the related document presenting section 204 and transmits the extracted task related document as the search result to the related document presenting section 204.

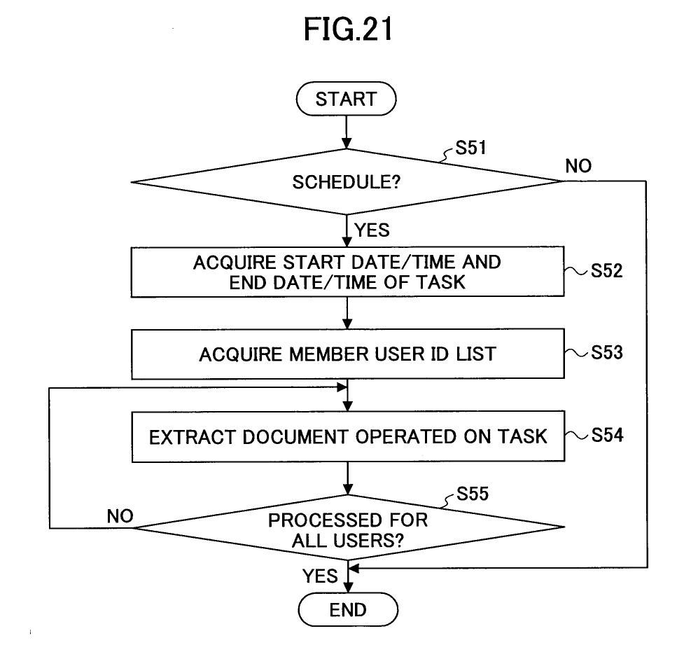

FIG. 21 is a flowchart showing the related document extraction process according to the second embodiment of the present invention.

First, the task related document presenting section 206 transmits the key task ID information including the ID of a key task as the key task information and the key document identifier information as the key document information. The task related document extracting section 109 searches the task information having the ID of the key task and determines whether the task represents a schedule (step S51). Here, when it is determined that the task does not represent a schedule, the process ends.

On the other hand, when it is determined that the task represents a schedule, the task related document extracting section 109 acquires the start date and time and the end date and time of the task (step S52). Next, the task related document extracting section 109 acquires the task member ID list (step S53) and searches for the document that the task member operated during the task time, namely between the start date and time and end date and time of the task (step S54).

Then, the task related document extracting section 109 determines whether searches are performed for all users. When it is determined that the searches are performed for all users, the process ends. On the other hand, when it is determined that the searches are not performed for all users, the process goes to step S54 (step S55).

Here, examples of the search formulas for searching the document operation event information in the focus event and in the copy/paste event are given as in formulas (11) and (12), respectively.

### (Formula 11)

Select*from “document operation event DB” where “user name”=“task member user” and (“start time”>=“task start date and time” and “start time”<“task end date and time”) or (“end time”>=“task start date and time” and “end time”<“task end date and time”) (11)

### (Formula 12)

Select*from “document operation event DB” where “user name”=“task member user” and (“execution time”>=“task start date and time” and “execution time”<“task end date and time”) (12)

The task related document extracting section 109 records the search result as the related document extraction result as shown in FIG. 15. Last, the task related document extracting section 109 creates the combination result as shown in FIG. 16. The task related document extracting section 109 transmits the combination result as shown in FIG. 16 to the task related document presenting section 204.

### [Task Related Document Presentation]

The task related document presenting section 206 presents the task related document. The task related document presenting section 206 requests the task related document extracting section 109 to search for a document related to the currently displayed task and causes the input/output section 201 to display the searched task related document. Or, the task related document presenting section 206 may be arranged to prompt a user to designate a task, request the task related document extracting section 109 to search for a document related to the designated task, and cause the input/output section 201 to display the searched for task related document.

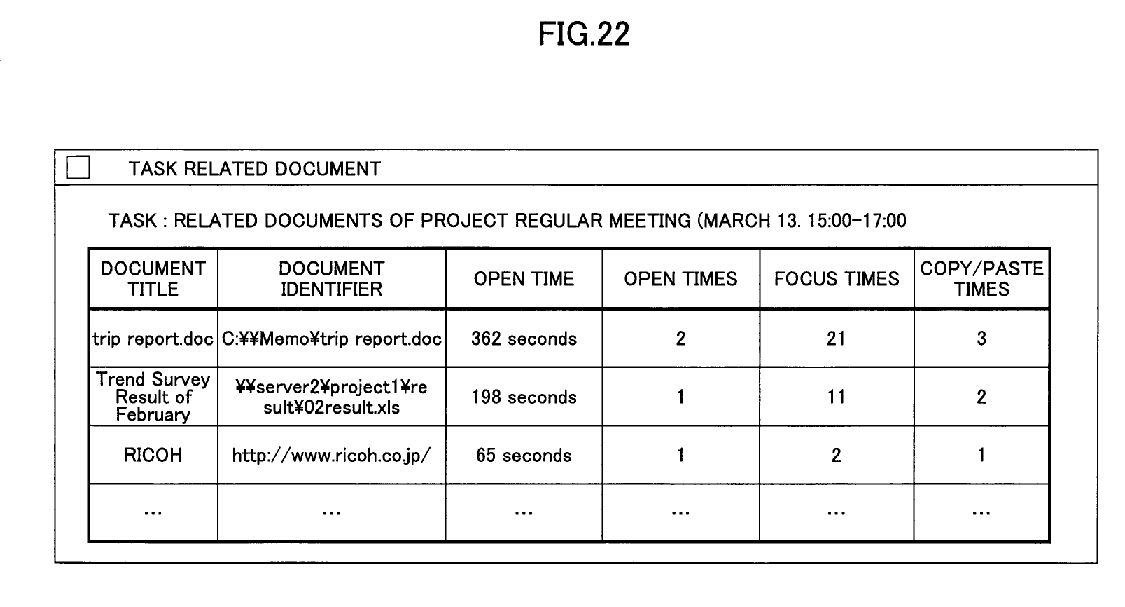

FIG. 22 shows an example of the task related document presentation. In this example, a user can sort the task related document search result by selecting the item and select the displayed document title or document identifier to open the selected document through the input/output section 201.

The information processing system 1 according to the second embodiment of the present invention can acquire the document operation event performed by a user regardless of, for example, the application and document management system used by a user for document operation and the document format, extract, for example, “a document used in a meeting” by using the time information of the task, and search for the task related document based on the document operation event performed by a user.

In this embodiment of the present invention, though the task related document extracting section 109 extracts the task related document based on the task information and the document operation event information. However, the present invention is not limited to the configuration and, for example, when the information of the task related document in the task information database 108 are managed as the task information by the task information managing section 107, the task related document may be extracted based on the task related document information and the document operation event information.

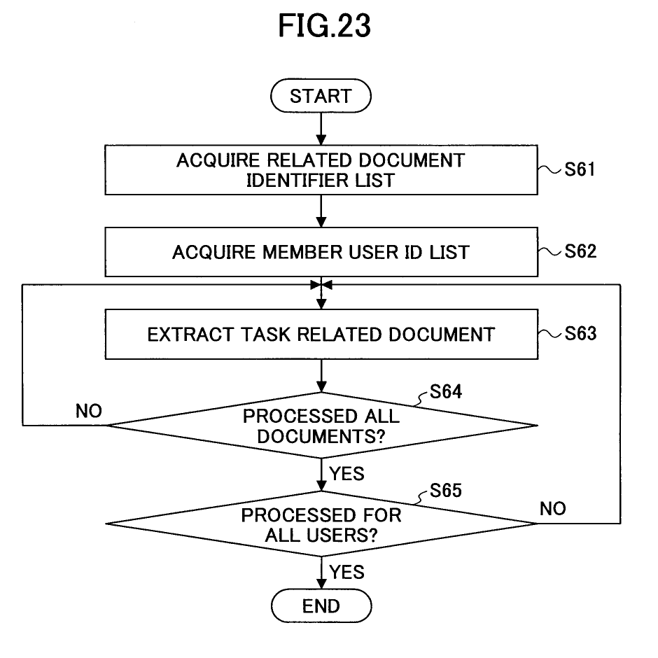

FIG. 23 is a flowchart of a modified example of the task related document extraction process according to the second embodiment of the present invention.

First, the task related document presenting section 206 transmits the key task ID information and the key document identifier information. The task related document extracting section 109 searches for the task information having the key task ID, acquires the related document identifier list and the task number ID (steps S61 and S62), and performs the related document search using the task member and the related document identifier as the key information (step S63). This related document extraction process is the same as the related document extraction process shown in FIG. 14.

Then, the task related document extraction unit 109 determines whether the searches are performed for all documents (step S64). When it is determined that the searches are not performed for all documents, the process goes back to step S63.

On the other hand, when it is determined that the searches are performed for all documents, the task related document extracting section 109 determines whether the searches are performed for all users (step S65). When it is determined that the searches are performed for all users, the process ends.

On the other hand, when it is determined that the searches are not performed for all users, the process goes back to step S63.

The task related document extracting section 109 records the searched for result as the related document extraction result as shown in FIG. 15. Last, the task related document extracting section 109 creates the combination result as shown in FIG. 17. The task related document extracting section 109 transmits the combination result as shown in FIG. 17 to the related document presenting section 204.

In this manner, the task related document based on the document operation event can be searched for from the information of the task related document having an explicit relationship.

Though, in this embodiment, the task relative document extraction process is performed based on three document operation events, the open/close event, the focus event, and the copy/paste event, the embodiments of the present invention are not limited to this embodiment and, for example, a user may designate a document operation event through the input/output section 201 and the task related document extraction process may be performed based on the designated document operation event.

Further, in this embodiment of the present invention, though the task related document extracting section 109 extracts the related document of the designated task document based on the document operation events of all users, the present invention is not limited to the embodiment and, for example, a user may designate a specific user through the input/output section 201 and the task related document of the designated document may be extracted based on the document operation event of the designated user.

### Third Embodiment

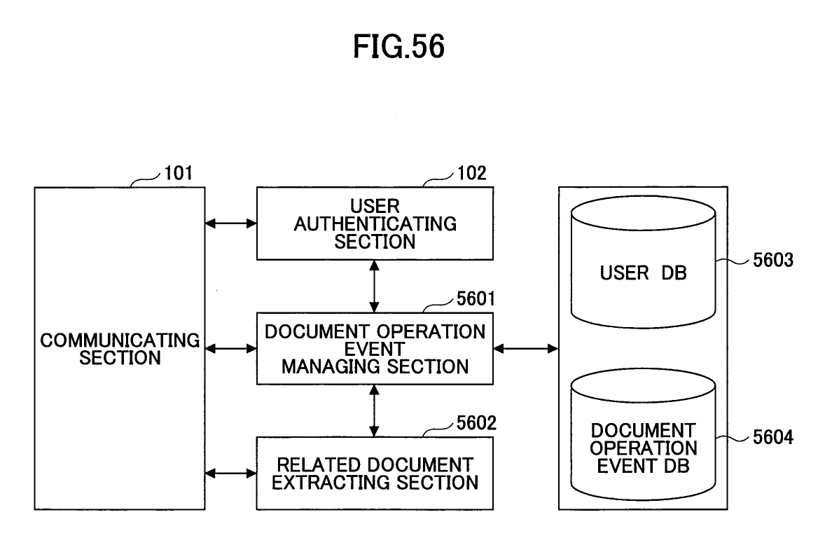

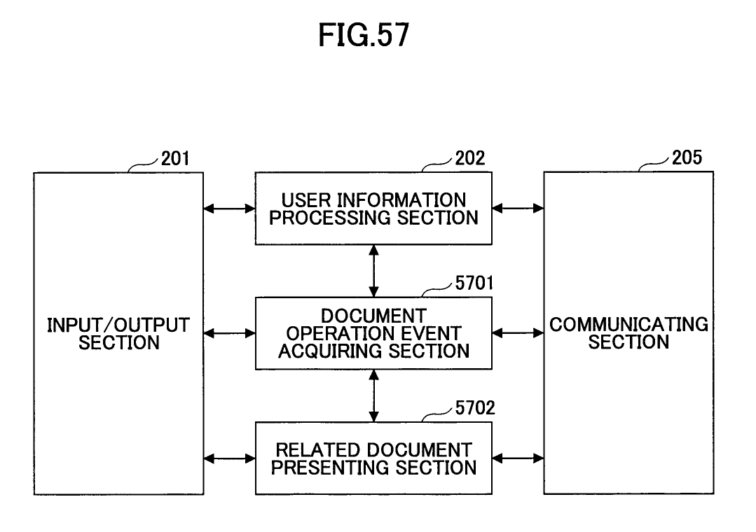

Next, the third embodiment of the present invention is described. FIGS. 56 and 57 are block diagrams showing the functions performed by a server and the client, respectively, according to a third embodiment of the present invention.

The same reference numerals for the elements of the server and the client in the first embodiment of the present invention are commonly used in the same elements of the server and the client in the third embodiment of the present invention and the descriptions of such same reference numerals are omitted herein.

As shown in FIG. 56, the server 20 includes the communicating section 101, the user authenticating section 102, a document operation event managing section 5601, a related document extracting section 5602, a user database 5603, and a document operation event database 5604.

The document operation event managing section 5601 manages the document operation event information transmitted from a document operation event acquiring section 5701, described below, in the document operation event database 5604.

Here, the document operation event refers to an event executed by the user on the client 30. In this embodiment, the document operation events refer to the events of opening/closing a document (opening/closing the document window), focusing-start/focusing-end the window (set the document window to be the foreground/background window), and copying/pasting the document (information is copied between the document windows via the clip board).

Further, the document operation event information refers to the information related to a document operation event. In this embodiment, the document operation event information includes the client identification information identifying the client 30 where the document operation event is performed, the operation target document information (a document title, a document identifier) related to the document of the performed document operation event, the application information related to the application where the document operation event is performed, an event name indicating the document operation event, the event execution time when the document operation event is performed, and the event unique information indicting the unique information of the document operation event.

The related document extracting section 5602 extracts a document related to a designated document (hereinafter “a related document”) using the document operation event information managed by the document operation event managing section 5601.

Here, in this embodiment, the user authenticating section 102, the document operation event managing section 5601, and the related document extracting section 5602 is realized by, for example, a program executed by the CPU 5502. The program is stored in the storage device 5505 or the RAM 5504. The user database 5603 and the document operation event database 5604 are each a storage medium such as the ROM 5503, the RAM 5504, and the storage device 5505.

Further, as shown in FIG. 57, the client 30 includes the input/output section 201, the user information processing section 202, a document operation event acquiring section 5701, a related document presenting section 5702, and the communicating section 205.

The document operation event acquiring section 5701 acquires the document operation event information.

The related document presenting section 5702 presents the search (extraction) result of the related document extracted by the related document extracting section to the user through the input/output section 201. The related document presenting section 5702 transmits the key document information used as a search key such as the currently viewed document and the document designated by a user (hereinafter “key document information”) to the related document extracting section 5602 to request to perform the related document search process. Further, the related document presenting section 5702 receives the search result from the related document extracting section 5602 and outputs the result on the input/output section 201.

Here, in this embodiment, the input/output section 201 is realized by an input device 5507 such as a keyboard and a mouse and an output device 5506 such as a liquid crystal display. The user information processing section 202, the document operation event acquiring section 5701, and the related document presenting section 5702 are realized by, for example, a program executed by a CPU (Central Processing unit) and stored in the storage device 5505 or the RAM 5504.

### [Document Operation Event Acquisition]

The document operation event acquiring section 5701 of the client 30 acquires the document operation information performed by a user on the client 30. In this embodiment, it is assumed that an OS (Operating System) having a window system as a GUI (Graphic User Interface) typified by Microsoft Windows (Trademark) is installed in the client 30.

Further, in this embodiment, it is assumed that the document event acquiring section 5701 acquires a user name, the document identification information (included in the operation target document information), a client identifier, a document title, an application name, an event name, an event execution time, and the event unique information as the document operation event information. In this embodiment, the document operation event information refers to the events of opening/closing the document, focusing-start/focusing-end the document, and copying/pasting the document.

It should be noted that since the information items acquired as the document operation event information in this embodiment are equal to the information items acquired in the first embodiment of the present invention except the document identification information, the explanations of the information items are omitted. The document identification information is calculated by a document identification information extracting section 5703 (not shown). The document identification information extracting section 5703 in the client extracts the document identification information based on the instruction from the document operation event acquiring section 5701. In this embodiment, the document identification information includes the location information (for example, the file path and the URL) indicating the information of the position where the document is stored and the document contents hash value calculated from the contents of the document.

The document operation event information acquired by the document operation event acquiring section 5701 is transmitted to the document operation event managing section 5601 so as to be stored and managed.

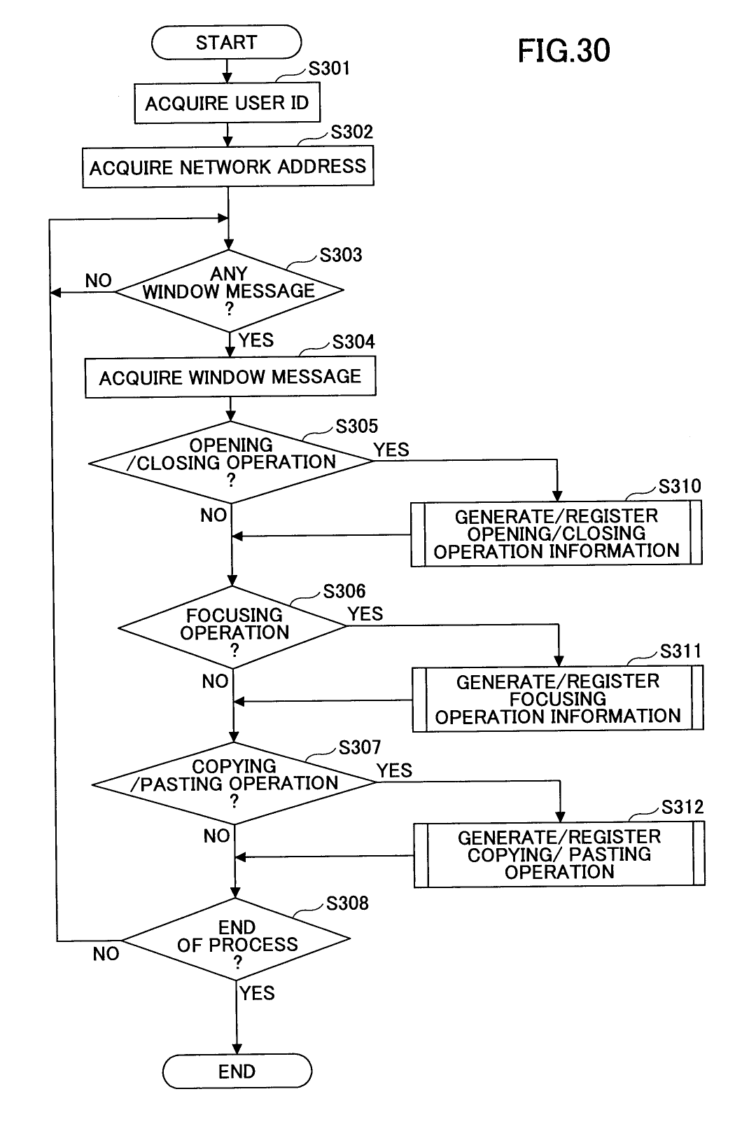

FIG. 30 is a flowchart showing a process of acquiring the document operation event information performed by the document operation event acquiring section 2701.

The document operation event acquiring section 5701 acquires the user ID from the user information processing section 202 (step S301). It should be noted that, in a case where the user authenticating section 102 acquires the login name when the user logs in, the log in name is acquired as the user name.

Next, the document operation event acquiring section 5701 acquires the IP address of the client 30 (step S302). The acquired IP address is used as the client identifier.

Next, the document operation event acquiring section 2701 monitors whether there is a window message transmitted to the window displayed on the client 30 (step S303). When, in step S303, there is a window message (detected) (YES in step S303), the window message is acquired (step S304). When, in step S303, there is no (detected) window message (NO in step S303), the process of monitoring whether there is a window message is continued.

Here, the window message refers to the information that Windows transmits to the application when, for example, Microsoft Windows is used as the OS of the client 30. More specifically, when a user operates the mouse or the keyboard for input or pushes the button or the menu, Windows detects the operation and a message of the operation detected by Windows is generated for informing. By receiving the generated information, each application determines what the user has operated and can respond to the received information.

As an example of the technique to detect whether there is a window message, Message Hook is well known. In this embodiment, it is assumed that, for example, the message hook technique is implemented and used as the technique to perform the processes of monitoring whether there is a window message (step S303) and acquiring the window message (step S304).

Next, the document operation event acquiring section 5701 determines whether the acquired window message in step S304 is a document operation event (steps S305, S306, and S307).

The window message includes a constant name or an integer value expressing the meaning of the window message. The constant name or the integer value of the window message acquired in step S304 is used in each of the determining steps S305, S306, and S307.

When the window message acquired in step S304 indicates the document operation event of the opening/closing operation (YES in step S305), the document event acquiring section 5701 acquires the document operation event information related to the opening/closing operation, and transmits the acquired document operation event information to the document operation event managing section 5601 to register the acquired document operation event information in the document operation event DB 5604 (step S310).

When the window message acquired in step S304 indicates the document operation event of the focusing-start/focusing-end operation (YES in step S306), the document event acquiring section 5701 acquires the document operation event information related to the focusing-start/focusing-end operation, and transmits the acquired document operation event information to the document operation event managing section 5601 to register the acquired document operation event information in the document operation event DB 5604 (step S311). Herein, the focusing-start/focusing-end operations refer to the operation to set the document window to be displayed as a foreground window/other than the foreground (background) window.

When the window message acquired in step S304 indicates the document operation event of the copying/pasting operation (YES in step S307), the document event acquiring section 5701 acquires the document operation event information related to the copy/paste operation, and transmits the acquired document operation event information to the document operation event managing section 5601 to register the acquired document operation event information in the document operation event DB 5604 (step S312).

Further, though it is not shown in FIG. 30, the document operation event acquiring section 5701 may be arranged so that, when the acquired window message in step S304 indicates the event of opening/closing operation or focusing-start/focusing-end operation of the document, the document operation event acquiring section 5701 may be arranged to transmit the information that the document operation event has been detected to the related document presenting section 5702.

After the registration of the document operation event of the window message in the document operation event DB 5604 is completed, the process goes back to step S303.

Further, when the acquired window message is not related to any of the document operation events, namely the window message is not related to any of the opening/closing operation, focusing-start/focusing-end operation, and the copying/pasting operation, the process goes back to step S303, and the document operation event acquiring section 5701 ends the process of acquiring the document operation event information from the window message.

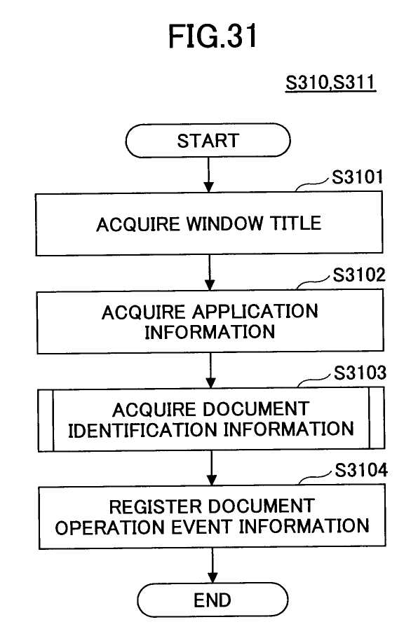

FIG. 31 is a flowchart showing a process of acquiring the document operation event information when the document operation event is related to the opening/closing operation (step S310).

The document operation event acquiring section 5701 acquires the title of the window (hereinafter “window title”) from the window message that is determined to be related to the opening/closing operation in step S305 (step S3101). The window title can be acquired by using the API called “GetWindowText ()”, which is one of the APIs included in Win32API.

Next, the document operation event acquiring section 5701 acquires the application information that is the information of the application used for operating the document displayed in the window (step S3102). The file name and the path name of the module executing the window can be acquired by using the API called “GetWindowText( )”. In this manner, the application displaying the document can be identified. In this embodiment, the file name of the module is used as the application name, namely the application information.

Next, the document operation event acquiring section 5701 acquires the document identification information from the document identification extracting section 5703 (step S3103).

The document operation event acquiring section 2701 transmits the acquired document operation event information to the document operation event managing section 5601 of the server. The transmitted document operation event information is registered in the document operation event DB 5604 by the document operation event managing section 5601 (step S3104).

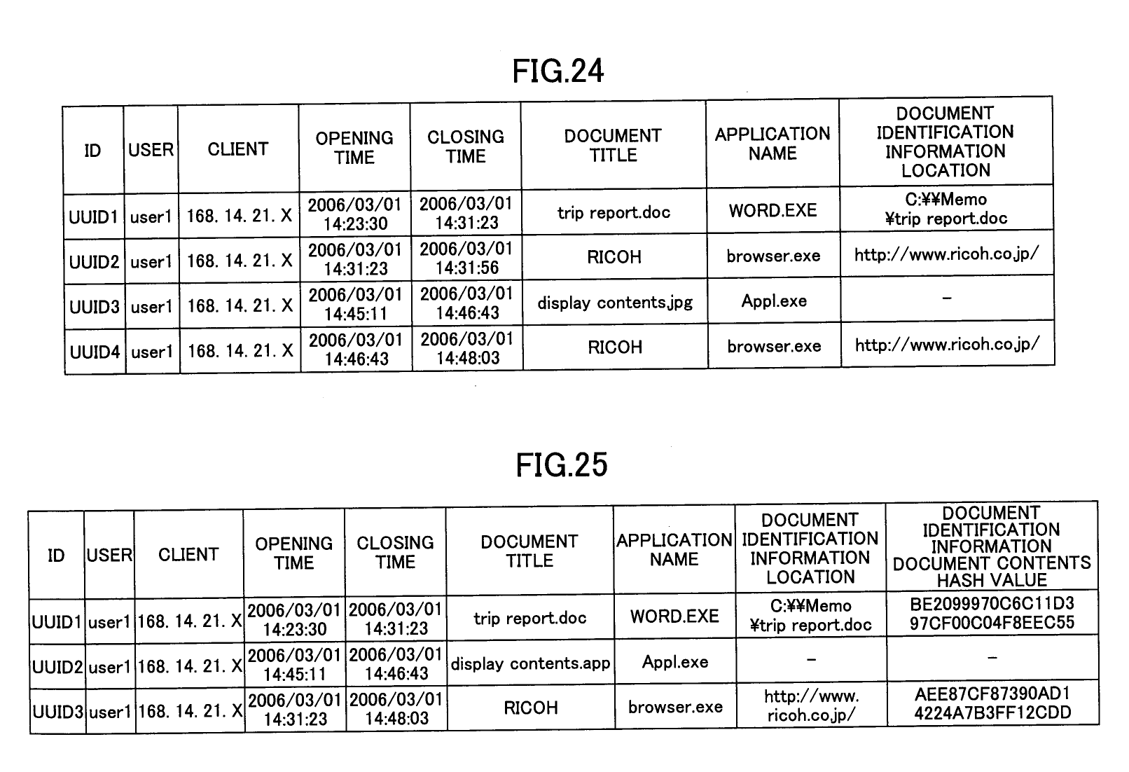

FIGS. 24 and 25 show the document operation event information, related to the opening/closing operations, acquired by the document operation event acquiring section 5701 and transmitted to the document operation event managing section 5601.

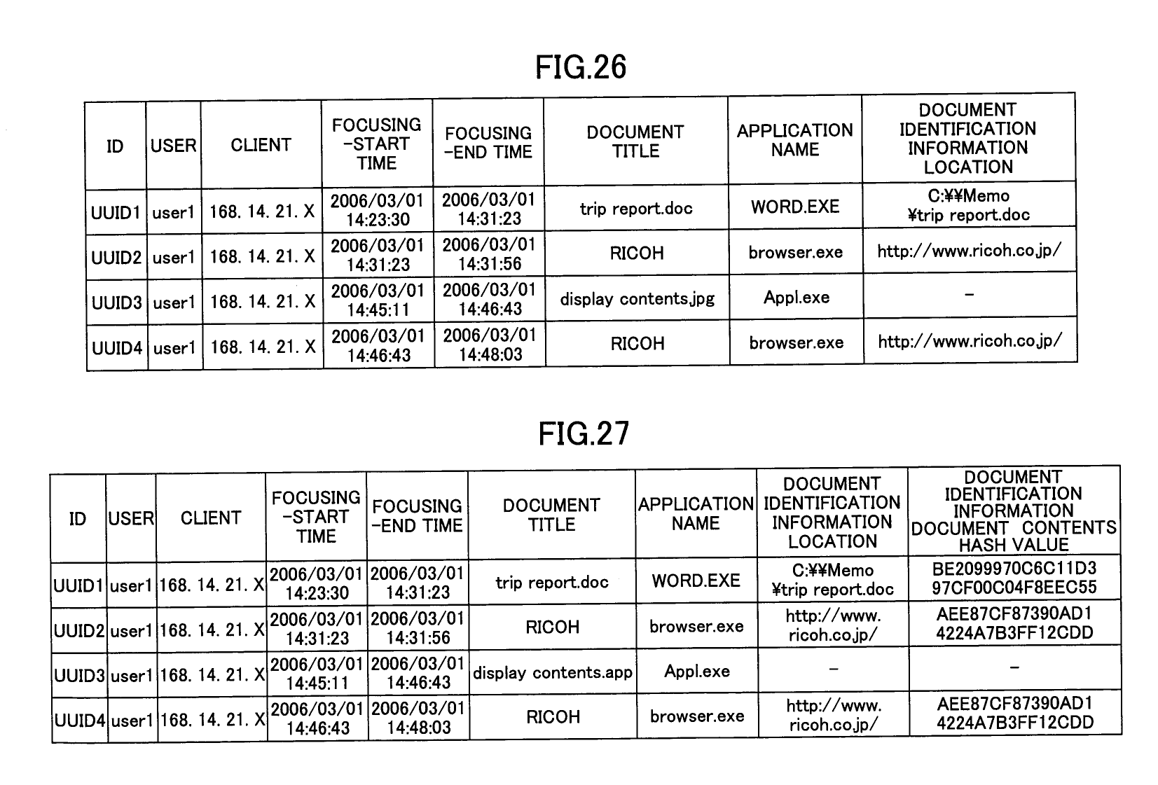

FIGS. 26 and 27 show the document operation event information, related to the focusing-start/focusing-end operations, acquired by the document operation event acquiring section 5701 and transmitted to the document operation event managing section 5601.

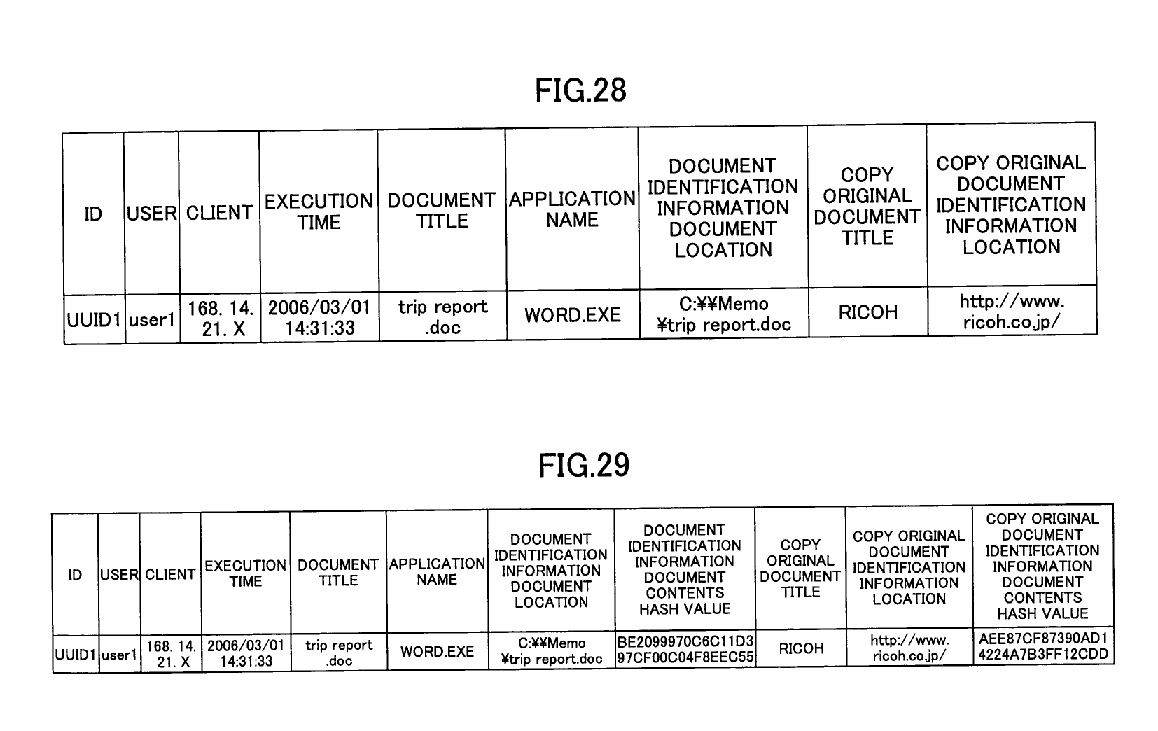

FIGS. 28 and 29 show the document operation event information, related to the copying/pasting operations, acquired by the document operation event acquiring section 5701 and transmitted to the document operation event managing section 5601.

In those figures, FIGS. 25, 27, and 29 show both the location information and the document contents hash value of the document operation event information as the document identification information.

FIGS. 24, 26, and 28 show the location information of the document operation event information as the document identification information.

When the document operation event information is registered, the document operation event acquiring section 5701 ends the operation of acquiring the document operation event information related to the opening/closing operation.

When the document operation event is related to the focusing-start/focusing-end operation, the process of acquiring the document operation event information related to the focusing-start/focusing-end operation (step S311) is performed in the same manner as in the process (steps S3101 through S3104) to acquire the document operation event information related to the focusing-start/focusing-end operation.

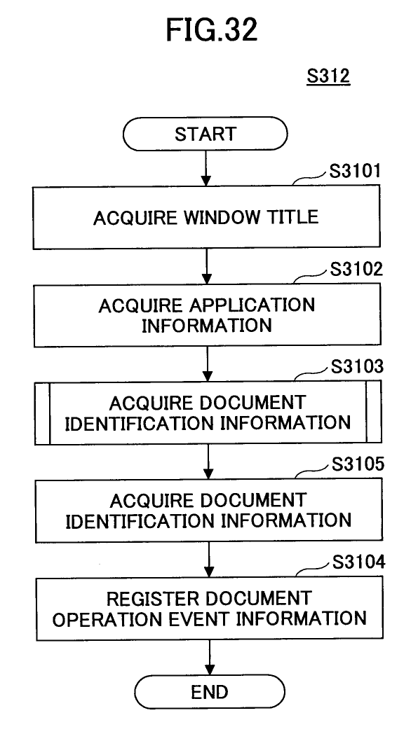

FIG. 32 is a flowchart showing a process of acquiring the document operation event information (step S312) when the document operation event is related to the copying/pasting operation. The process shown in FIG. 32 is the same as the processes of acquiring the document operation event information when the document operation event information is related to the copying/pasting operation (step S310) or focusing-start/focusing-end operation (step S311) shown in FIG. 31 except that a process of acquiring the copy original document information (step S3105) is added. Therefore, in the following, only the different process of acquiring the copy original document information is described.

When the paste event has occurred, the document operation event acquiring section 5701 acquires the copy original document information (step S3105). The occurrence of the copying/pasting event is checked by monitoring the clipboard (where information is temporarily stored) and the key input. In a system using Microsoft Windows (Trademark), since it is known that the change on the clipboard can be detected by using the API called “SetClipboardViewer( )”, this API is used in this embodiment. As the copy original document information, the document title and the document identification information (the location information and the document contents hash value) of the copy original document are acquired. The copy original document information can be acquired by acquiring the window information of the copy original document from the clipboard information and then performing the document identification information acquiring process on the copy original document (step S3103).

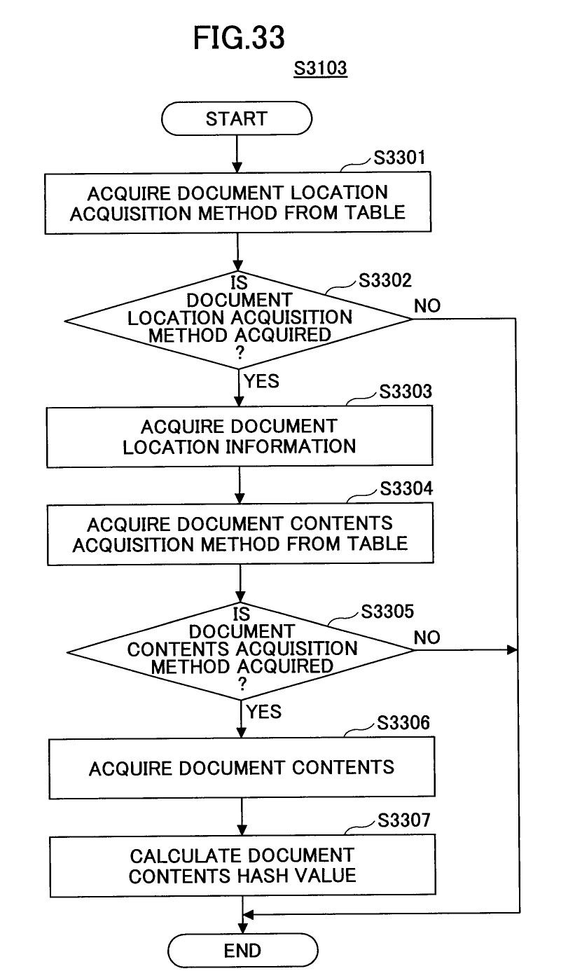

FIG. 33 is a flowchart showing a process of acquiring the document identification information by the document identification extracting section 5703 (step S3103).

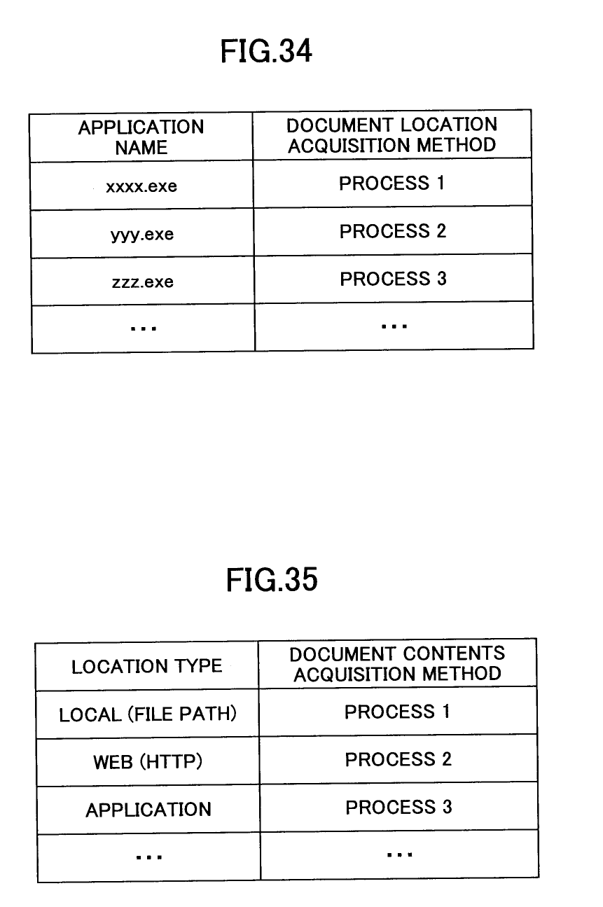

The document identification information extracting section 5703 acquires the location acquisition method corresponding to the application information from the location acquisition processing method table as shown in FIG. 34 using the application information acquired in step S3102 as a key (step S3301).

As a technique to acquire the document location information, in a case of Microsoft Windows (Trademark), there is a technique called “Automation” capable of disclosing the internal object or function of an application or a service to an external application or service. When the application is Automation-compliant, the location information can be acquired in most cases. Even when the application is not Automation-compliant, but if the application displays the location information in the document window, the location information may be acquired by the above method of acquiring the window message. As described above, the process of acquiring the document location information may be different depending on the application.

Therefore, in this embodiment, the document location acquisition method corresponding to each application is created and a document location acquisition method table in which the application information is associated with the created document location acquisition method as shown in FIG. 34 is stored in, for example, the ROM 5503, the RAM 5504, or the storage device 5505. In this manner, the document location information can be acquired by referring the document location acquisition method corresponding to the application using the application information acquired in step S3102 as a key (step S3301). As a result, the document location information can be acquired regardless of whether the application is Automation-compliant.

The document identification information extracting section 5703 determines whether the document location acquisition method corresponding to the application information is acquired in step S3301 (step S3302). When it is determined that the document location acquisition method is acquired (YES in step S3302), the process goes to step S3303. When it is determined that the document location acquisition method is not acquired (NO in step S3302), the process of acquiring the document location is ended.

The document identification information extracting section 5703 acquires the document location information based on the document location acquisition method acquired in step 3301 (step S3303).

Next, the document identification information extracting section 5703 acquires the document contents acquisition method corresponding to the document location information from the document contents acquisition method table as shown in FIG. 35 using the document location information acquired in step S3303 as a key (step S3304).

Here, in this embodiment, it is assumed that, when the document file is a binary file, the document contents refer to the actual data part of the file excluding the header part located at the head of the file.

The method of acquiring the document contents may differ depending on the location where the document is stored (recorded) and the file format of the document. For example, when the document is a file stored locally (in the client 30), the file may be opened to acquire the contents of the file. On the other hand, when the document is, for example, a Web document, the document contents may be acquired through a network.

Therefore, in this embodiment, the document contents acquisition method corresponding to, for example, each location or file format of the document is created and a document contents acquisition method table in which, for example, the location and the file format of the documents are associated with the created document location acquisition method as shown in FIG. 35 is stored in, for example, the ROM 5503, the RAM 5504, or the storage device 5505. In this manner, the document contents can be acquired by referring to the document contents acquisition method corresponding to the document location information or application information using the document location information acquired in step S3303 or the application information as a key (in this embodiment, the number of file formats of the applications may be limited in most cases, so the application information is used) (step S3304). As a result, since the document location information can be acquired, the document contents can be accordingly acquired through the acquired document contents acquisition method.

The document identification information extracting section 5703 determines whether the document contents acquisition method corresponds to the document location information or application information in step S3304 (step S3305). When the document contents acquisition method is acquired in step S3304 (YES in step S3305), the process goes to step S3306. When the document contents acquisition method is not acquired in step S3304 (NO in step S3305), the document identification information acquiring process is ended.

Next, the document identification information extracting section 5703 acquires the document contents based on the information location information acquired in step S3303 and the document contents acquisition method acquired in step S3304 (step S3306). Here, since the document location information is the information where the document is actually stored, the document location information is necessary to acquire the document contents.

Next, the document identification information extracting section 5703 calculates the hash value of the document contents acquired in step S3306 (step S3307). To calculate the hash value, a specific length of hash value of the given input (document contents) is calculated using an output hash function. In this embodiment, it is assumed that the MD5 hash function outputting a 128-bit hash value is used.

The document identification information extracting section 5703 transmits the document location information acquired in step S3303 and the document contents hash value acquired in step S3307 to the document operation event acquiring section 5701 as the document identification information, and the document identification information acquiring process is ended.

### [Document Operation Event Management]

The document operation event managing section 5601 of the server 20 records the document operation event information, received from the document operation event acquiring section 5701 of the client 30, in the document operation event DB 5604. The document operation event information is stored in such a manner that the document operation events (document operation event information of the opening/closing operation, the focusing-start/focusing-end operation, and the copying/pasting operation) are separated from one another. In this embodiment, it is assumed that the database items managed in the document operation event DB are the same as the items shown in FIGS. 24 through 29.

Further, regarding the document operation event information of the opening/closing operation and the focusing-start/focusing-end operation, since it is necessary to register two times for their start and end timings, when the data at end timing are registered, it is assumed that the document operation event information is updated by using the ID of the document operation event information already stored in the document operation event DB as a key.

### [Related Document Presentation]

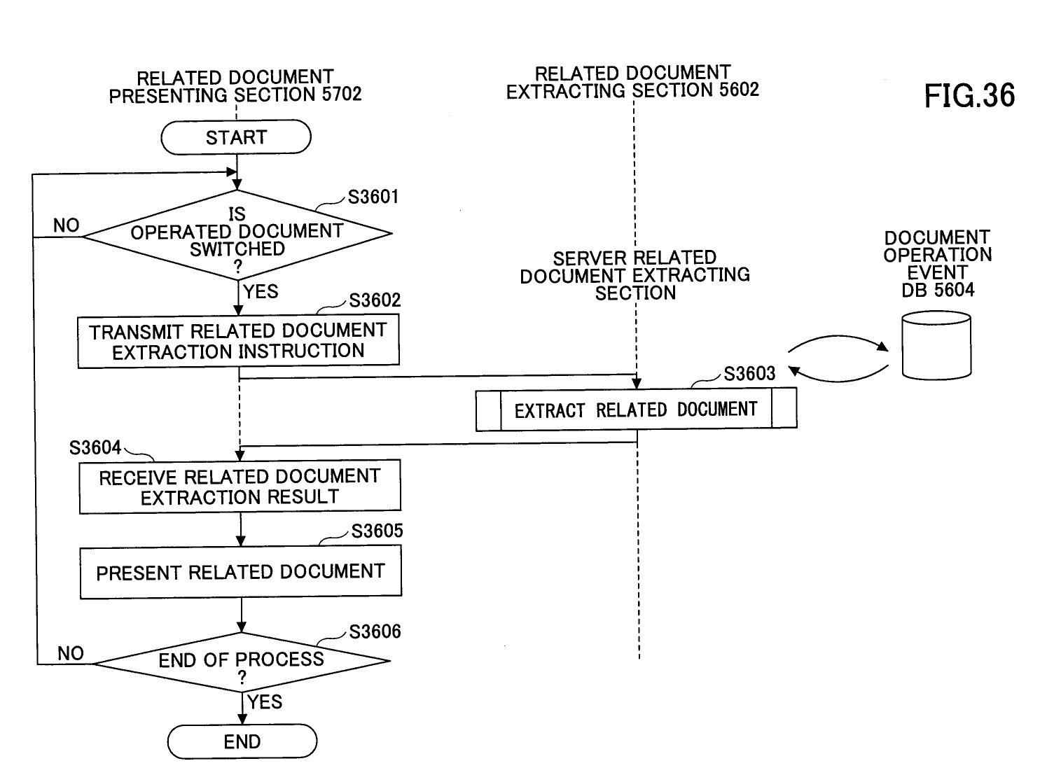

The related document presenting section 5702 of the client 30 presents the related document. FIG. 36 is a flowchart showing a process of the related document presentation executed by the related document presenting section 5702 of the client 30.

The related document presenting section 5702 acquires the document operation event information from the document operation event acquiring section 5701 and determines whether the operated document of the target document operated by a user (or active document) is switched over(step S3601).

Further, the document operation event acquiring section 5701 may be arranged so that, when a specific document operation event is detected, the document operation event acquiring section 5701 informs the related document presenting section 5702 of the document operation event. In this case, the above determination step (step S3601) executed by the related document presenting section may be changed as follows: “The related document presenting section 5702 determines that the operated document is switched when the related document presenting section 5702 receives a document operation event occurring notice from the document operation event acquiring section 5701”.

When the related document presenting section 5702 determines that “the operated document is switched” (YES in step S3601), the related document presenting section 5702 sends (requests) a related document extraction instruction to the related document extracting section 5602 of the server 20 to extract the related document (step S3602).

When the related document presenting section 5702 determines that “the operated document is not switched” (NO in step S3601), the process goes back to step S3601 without executing the steps S3602 through S3604.

The related document presenting section 5702 receives the related document extraction result from the related document extracting section 5602 as the response to the related document extraction instruction transmitted to the related document extraction section 5602 (step S3604). The related document extraction result is the result of the related document extracting process (in step S3603) where the related document extracting section 5602 extracts the related operation event information stored in the document operation event DB 5604 based on the related document extraction instruction.

The related document presenting section 5702 presents the related document through the input/output section 201 based on the related document extraction result received in step S3604 (step S3605).

### [Related Document Extraction]

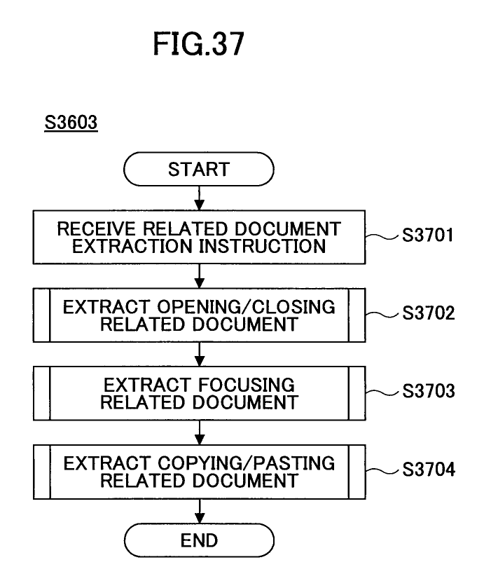

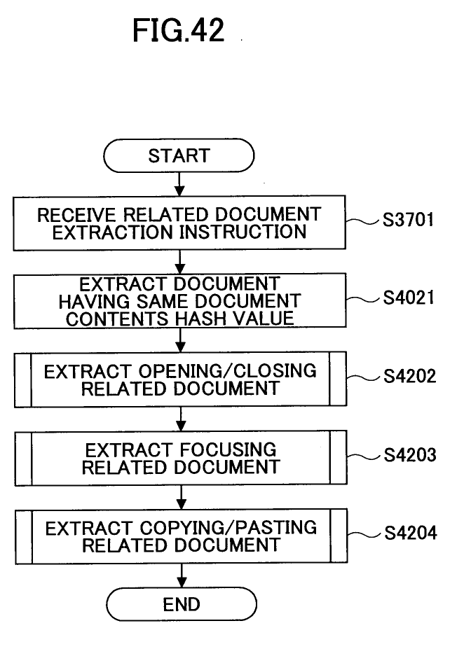

The related document extracting section 5602 of the server 20 extracts a related document based on the related document extraction instruction transmitted from the related document presenting section 5702 and returns a result of the extraction to the client that has transmitted the extraction instruction. Here, the related document extraction instruction transmitted from the related document presenting section 5702 of the client 30 includes the key document identification information used as a key upon the extraction. In this embodiment, the key document identification information, included in the extraction instruction for extracting a related document, includes the document location information and the document contents hash value of the key document (that is currently operated by a user). It should be noted that there are some cases where the document location information may be acquired but the document contents hash value may not be acquired depending on the document. Because of this feature, a case where the related document extracting section 5602 of the server when the related document extraction instruction includes the document location information of the key document as the key document identification information (FIG. 37); and a case where the related document extracting section 5602 of the server when the related document extraction instruction includes the document location information and the document contents hash value of the key document as the key document identification information (FIG. 42) are separately described below.

A related document extraction process based on the related document extraction instruction executed by the related document extracting section 5602 of the server 20 is described with reference to the flowchart of FIG. 37. The flowchart of FIG. 37 shows an extraction process when the related document extraction instruction includes the location information of the key document as the key document identification information.

The related document extracting section 5602 receives the related document extraction instruction transmitted from the related document presenting section 5702 (step S3701).

In this case (where the document contents hash value is not used), whether the documents are identical is determined by whether the document location information of the documents is identical.

Next, the related document extracting section 5602 extracts the opening/closing operation related document related to the key document from the document operation event information related to opening/closing operations based on the related document extraction instruction (step S3702).

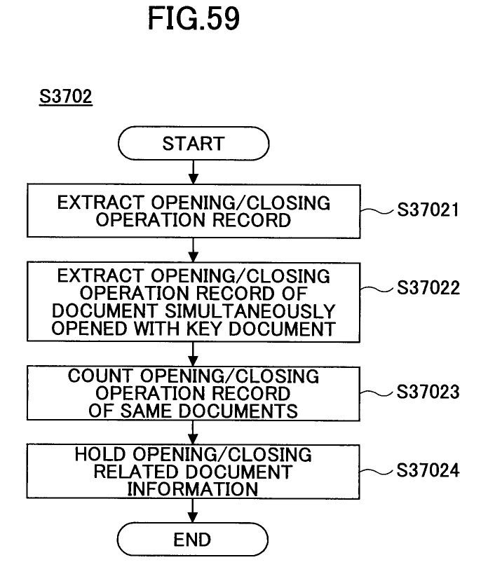

In the following, a process of extracting the opening/closing operation related document information (S3702) is described with reference to FIG. 59.

The related document extracting section 5602 extracts all records (opening/closing operation records) of the document operation event information related to the opening/closing operations of the document having the same document location information as the key document included in the related document extraction instruction received in step S3701 (step S37021).

Namely, by referring to the opening time (time when the document is opened) and the closing time (time when the document is closed) of the extracted opening/closing operation records, it is possible to determine the time when the same document as the key document has been open and when the document that is regarded as the same document as the key document has been open.

Next, the related document extracting section 5602 extracts the opening/closing operation record of the document that has been open between the “opening time” and the “closing time” of the opening/closing operation records extracted in step S37021. In other words, the related document extracting section 5602 extracts the opening/closing operation record of the document that has been open when the key document has been open (step S37022). In this manner, the document that is open when the key document is open can be determined.

In the following, the extraction conditional formulas used for the process in above step S37022 are provided.

### (Formula 13)

(“opening time”>=“key document opening time” and “closing time”>“key document opening time”) or (“opening time”>−“key document closing time” and “closing time”>“key document closing time”)

By referring to the document location information of the opening/closing operation records extracted in step S37022, the number of the opening/closing operation records having the same document location information is counted (step S37023). This process can determine how many times the document that is open simultaneously when the key document is open has been open simultaneously when the key document has been open.

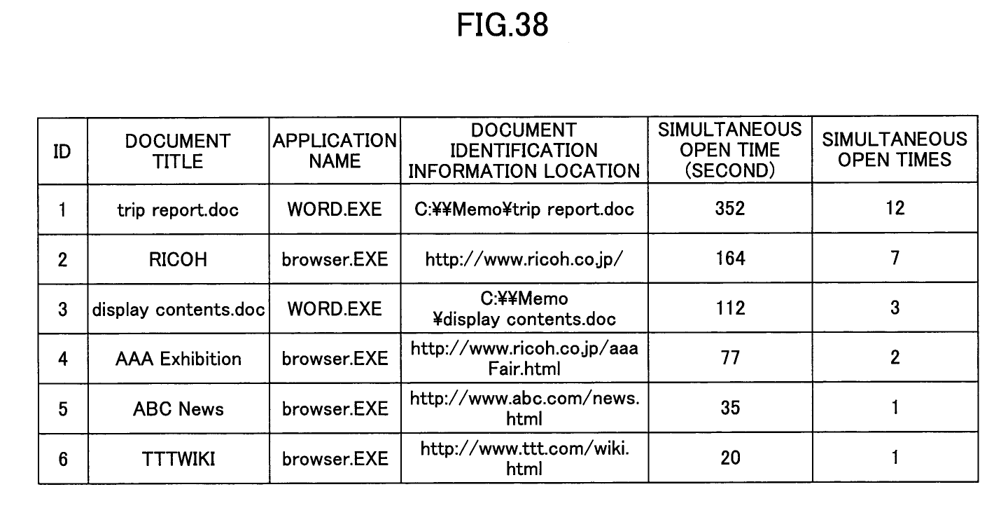

The result obtained in above step S37023 is held as the opening/closing related document information (step S37024). FIG. 38 shows examples of the held opening/closing related document information.

Next, the related document extraction section 5602 extracts the focusing-start/focusing-end operation related document related to the key document included in the related document extraction instruction from the document operation event information related to the focusing-start/focusing-end operations (step S3703).

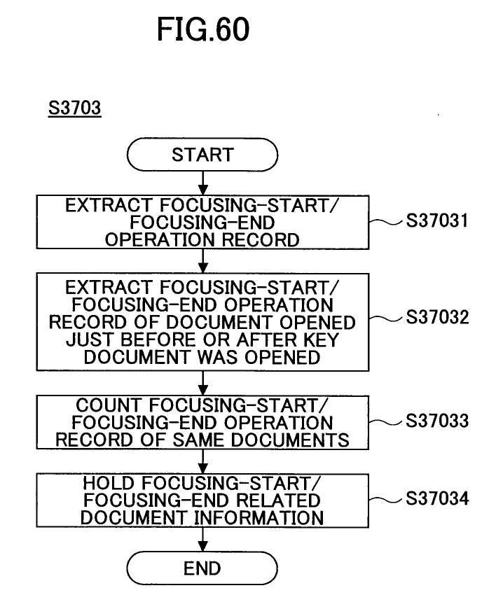

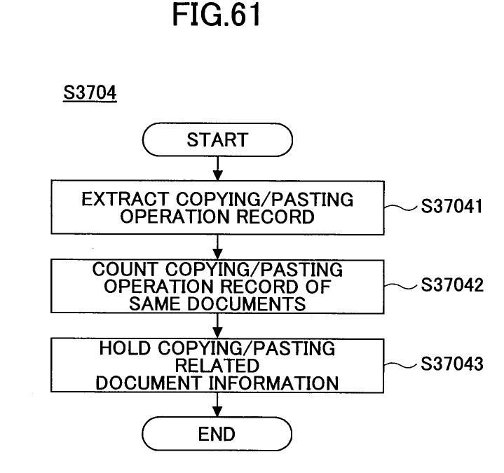

In the following, a process of extracting the focusing-start/focusing-end operation related document information (step S3703) is described with reference to FIG. 60.

The related document extracting section 5602 extracts all records (focusing-start/focusing-end operation records) of the document operation event information related to the focusing-start/focusing-end operations of the document having the same document location information as the key document included in the related document extraction instruction received in step S3701 (step S37031). This process can determine the time when the same document as the key document has been focused and when the document that is regarded as the same document as the key document has been focused.

Next, the related document extracting section 5602 extracts the focusing-start/focusing-end operation records that have been focused just before the “focusing-start time” and just after the “focusing-end time”, namely the focusing-start/focusing-end operation records related to the document that is focused just before or just after the key document is focused, of each focusing-start/focusing-end operation record extracted in step S37031. This process determines the document that is focused just before or just after the key document is focused.

In the following, the extraction conditional formulas used for the process in above step S37032 are provided.

### (Formula 14)

(“focusing-start time”>=“key document focusing-end time” and “focusing-start time”<“key document focusing-end time”+5 seconds) or (“focusing-end time”<=“key document focusing-start time” and “focusing-end time”>=“key document focusing-start time”−5 seconds)

By referring to the document location information of the focusing-start/focusing-end operation records extracted in step S37032, the number of the focusing-start/focusing-end operation records having the same document location information is counted (step S37033). This process can determine how many times the document that is focused just before or just after the key document is focused has been focused just before or just after the key document has been focused.

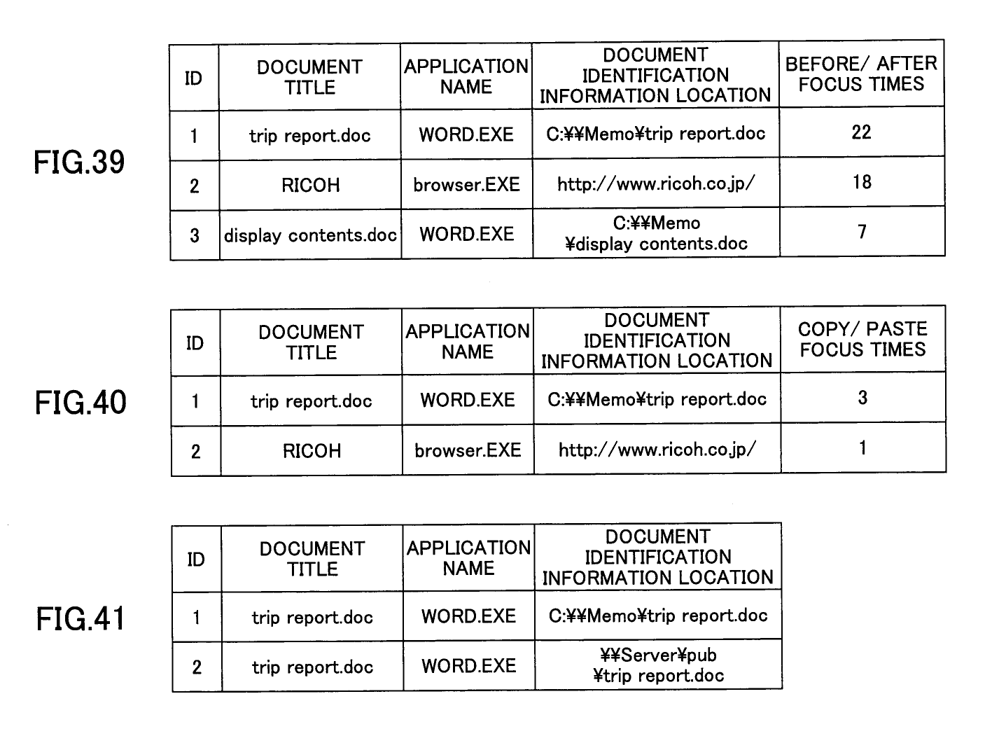

The result obtained in above step S37033 is held as the focusing-start/focusing-end related document information (step S37034). FIG. 39 shows examples of the held focusing-start/focusing-end related document information.

Next, the related document extraction section 5602 extracts the copying/pasting operation related document related to the key document included in the related document extraction instruction from the document operation event information related to the copying/pasting operations (step S3704).

In the following, a process of extracting the copying/pasting operation related document information (step S3704) is described with reference to FIG. 61.

The related document extracting section 5602 extracts the “copying/pasting destination operation record” and “copying/pasting original operation record” (step S37041). The “copying/pasting destination operation record” refers to the record of the document operation event information related to the copying/pasting operation including the document location information same as that of the key document included in the related document extraction instruction received in step S3701. Similarly, the “copying/pasting original operation record” refers to the record of the document operation event information related to the copying/pasting operation having the document location information in the copy original document location information. This process can easily extract a document even when the document the same as the key document or the document that is regarded as the same document as the key document is recorded as the copy original document or the paste destination document.

Next, the related document extracting section 5602 counts the number of copying/pasting operation records having the same document location information as the document location information of the copying/pasting original operation record and as the copy original document location information of the copying/pasting destination operation record, each extracted in step S37041 (step S37042). This process determines the document related to the copying/pasting operation of the key document.

Next, the related document extracting section 5602 holds the result obtained in above step S37042 as the copying/pasting related document information (step S37043). FIG. 39 shows examples of the held copying/pasting related document information.

Next, the related document extracting section 5602 transmits the opening/closing related document information which is the result of the process in step S3702, the focusing-start/focusing-end related document information which is the result of the process in step S3703, and the copying/pasting related document information which is the result of the process in step S3704 to the related document presenting section 5702 of the client 30 as the related document extraction result.

(When a Document Contents Hash Value is Used)

Next, a process of extracting a related document based on the related document extraction instruction executed by the related document extracting unit 5602 of the server 20 is described with reference to the flowchart of FIG. 42. The flowchart of FIG. 42 shows an extraction process when the related document extraction instruction includes not only the document location information but also the document contents hash value of the key document as the key document identification information. It should be noted that the same step number as shown in FIG. 37 is used when the process of the step is the same and the description of such process is omitted.

The related document extracting section 5602 extracts the document having the same document contents hash value as that of the key document included in the related document extraction instruction received in step S3701 from the document operation event information stored in the document operation event DB 5604, acquires the document title, the application name, and the document location information of the extracted document operation event information, and holds the acquired information as the same document information (step S4201). FIG. 41 shows examples of the same document information. Namely, when the document contents hash value is used, the document having the same document contents hash value as that of the key document is treated as the same document or the document regarded as the same document. As a result, even when a document has different document location information from that of the key document but has the same document contents (or document contents hash value) as that of the key document, the document can be regarded as the same document.

Next, the related document extracting section 5602 extracts the opening/closing operation related document related to the key document based on the related document extraction instruction from the document operation event information related to the opening/closing operation (step S4202).

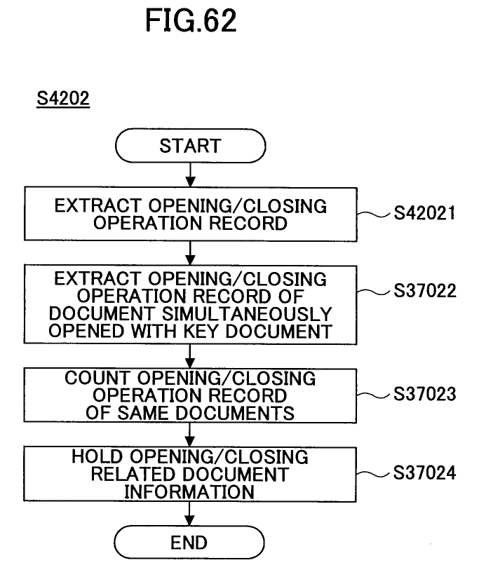

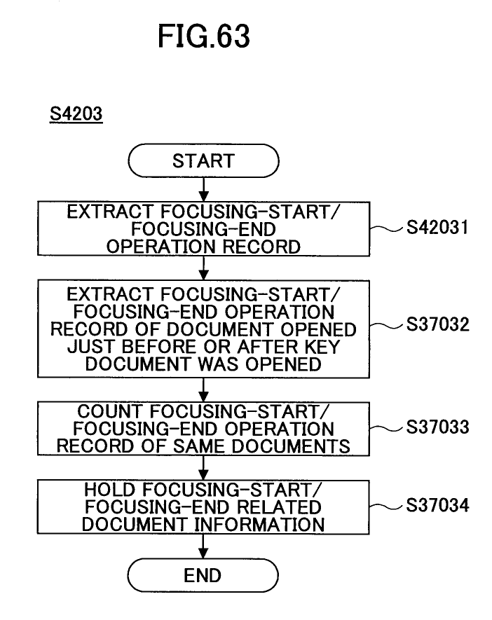

In the following, a process of extracting the opening/closing operation related document information (step S4202) is described with reference to FIG. 62.

The related document extracting section 5602 extracts all the records of the document operation event information related to the opening/closing operation (opening/closing operation record) having the same document contents hash value as that of the key document included in the related document extraction instruction received in step S3701 and the same document location information as that of the document included in the same document information extracted in step S4201 (step S42021). This process determines the time when the document the same as the key document and the document regarded as the same document as the key document have been open. Since the further processes applied to the extracted opening/closing operation record are the same as those in case where no document contents hash value is used, the descriptions of the processes are omitted herein.

Next, the related document extracting section 5602 extracts the focusing-start/focusing-end operation related document related to the key document based on the related document extraction instruction from the document operation event information related to the focusing-start/focusing-end operation (step S4203).

In the following, a process of extracting the focusing-start/focusing-end operation related document information (step S4203) is described with reference to FIG. 62.

The related document extracting section 5602 extracts all the records of the document operation event information related to the focusing-start/focusing-end operation (focusing-start/focusing-end operation record) having the same document contents hash value as that of the key document included in the related document extraction instruction received in step S3701 and the same document location information as that of the document included in the same document information extracted in step S4201 (step S42031). This process determines the time when the document the same as the key document and the document regarded as the same document as the key document were being focused. Since the further processes applied to the extracted focusing-start/focusing-end operation record are the same as those in case where no document contents hash value is used, the descriptions of the processes are omitted herein.

Next, the related document extracting section 5602 extracts the copying/pasting operation related document related to the key document based on the related document extraction instruction from the document operation event information related to the copying/pasting operation (step S4204).

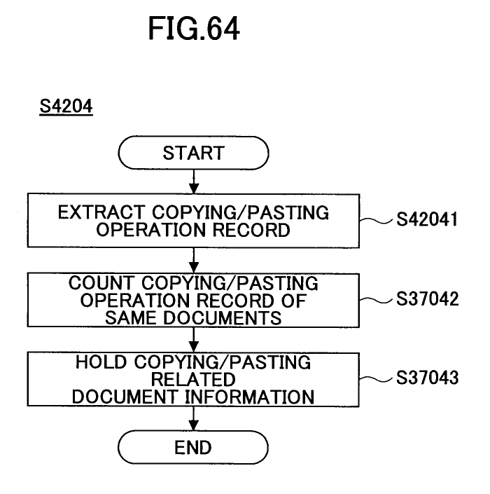

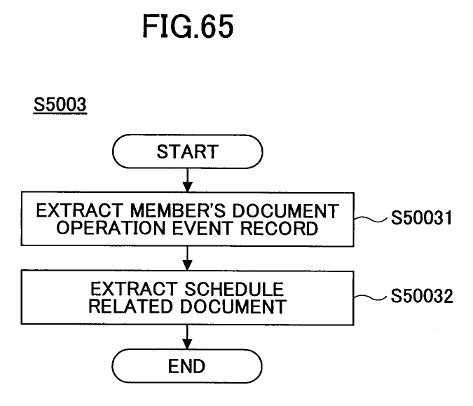

In the following, a process of extracting the copying/pasting operation related document information (step S4204) is described with reference to FIG. 64.

The related document extracting section 5602 extracts all the records of the document operation event information related to the copying/pasting operation (copying/pasting operation record) having the same document contents hash value as that of the key document included in the related document extraction instruction received in step S3701 and the same document location information as that of the document included in the same document information extracted in step S4201 (step S42041). This process can easily extract a document even when the document the same as the key document and the document that is regarded as the same document as the key document is recorded as the copy original document or the past destination document. Since the further processes applied to the extracted copying/pasting operation record are the same as those in case where no document contents hash value is used, the descriptions of the processes are omitted herein.

Next, the related document extracting section 5602 transmits the opening/closing related document information which is the result of the process in step S4202, the focusing-start/focusing-end related document information which is the result of the process in step S4203, and the copying/pasting related document information which is the result of the process in step S4204 to the related document presenting section 5702 of the client 30 as the related document extraction result.

### [Related Document Presentation]

Next, a related document presentation process executed by the related document presenting section 5702 of the client 30 (step S3605) is described.

The related document presenting section 5702 receives the related document extraction result from the related document extracting section 5602 of the server 20 (step S3604).

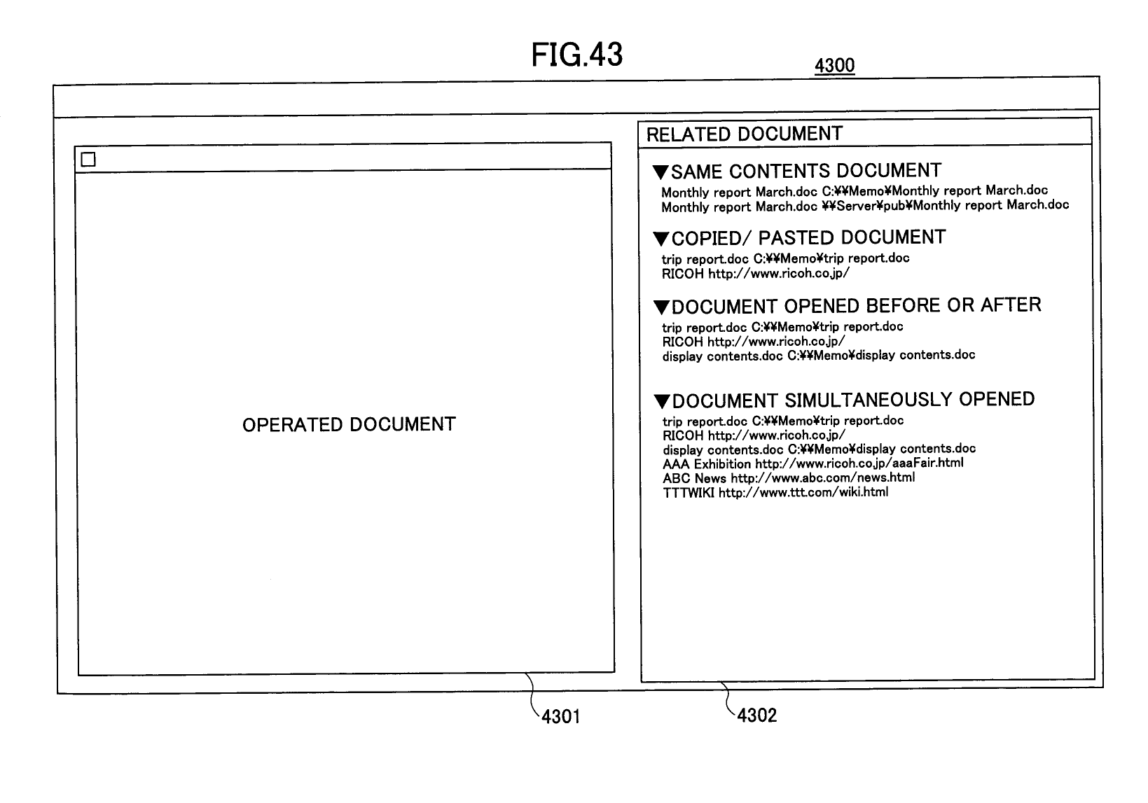

The related document presenting section 5702 displays both the related document extraction result received in step S3604 and the currently operated document (key document) (step S3605). FIG. 43 shows a presentation example 4300 of the related document in the related document presentation process in step S3604 displayed on the input/output section 202 of the client 30. The presentation sample shown in FIG. 43 includes an area 4301 displaying the document currently operated by the user (key document) and an area 4302 displaying the related document extraction result received in step S3604.

It should be noted that the related document to be displayed to the user may be determined by applying a predetermined threshold value or weighting value to the simultaneous open time or the simultaneous open times, the before/after focus times, and the copy/paste times when the opening/closing, the focusing-start/focusing-end, and the copying/pasting operation are selected, respectively, from the related document extraction result so that an only higher related document can be displayed.

In the related document presentation 4300, a user can select a desired document from, for example, the related documents displayed in the related document display area 4302 and display the selected document in the key document display area 4301. In this case when the displayed document is switched, it is determined that the operated document is switched (step S3601), and a new document related to the new operated document is required to be extracted. Further, since the operated document is switched, the document operation event information related to the focusing-start/focusing-end operation is generated and transmitted to the document operation event information managing section 5601. Because of the feature, the user can easily acquire and see the related document related to the currently operated document simply by selecting the document related to the operated document.

As described above, according to the embodiment of the present invention, since the document contents hash value calculated from the document contents is used to extract the related document, the identity of the document contents can be determined even when the document is copied or distributed as being attached to a mail message. Namely, since a document having different document location information and the same document contents can be treated as the same document, even when a copied document is operated for the first time, the history of the document operation event information of its original document is able to be used, and the related document of the copied document can be displayed.

### Fourth Embodiment

Next, a fourth embodiment of the present invention is described. In the fourth embodiment, a document related to a user's schedule is extracted and displayed as the related document using the document operation event information.

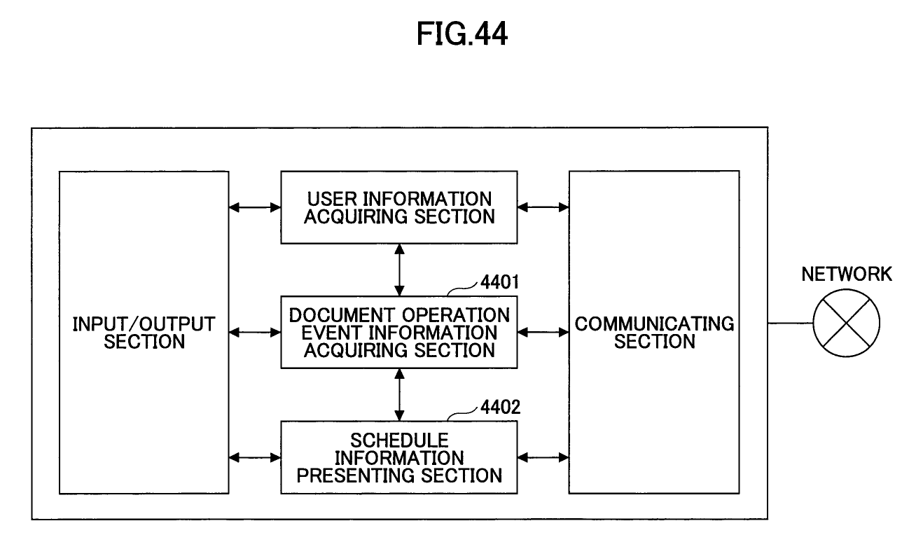

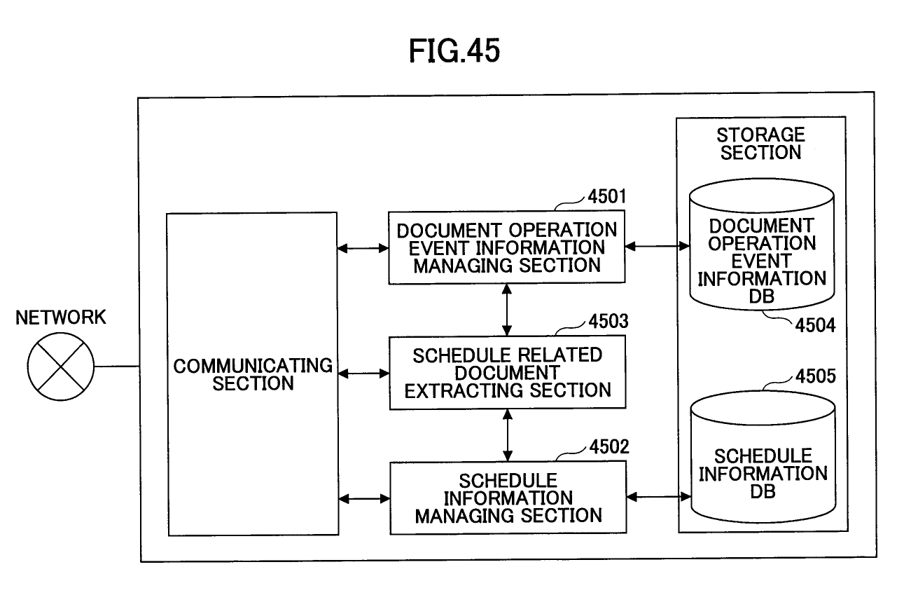

FIGS. 44 and 45 show exemplary configurations of the client and the server, respectively, according to the fourth embodiment of the present invention. In the following, only the parts different from those of the configuration of the third embodiment of the present invention are described.

In the fourth embodiment of the present invention, a document operation event information acquiring section 4401 acquires the document operation event information related to the focusing-start/focusing-end operation and the key input operation information representing a user's key input to the document as the information operation event information.

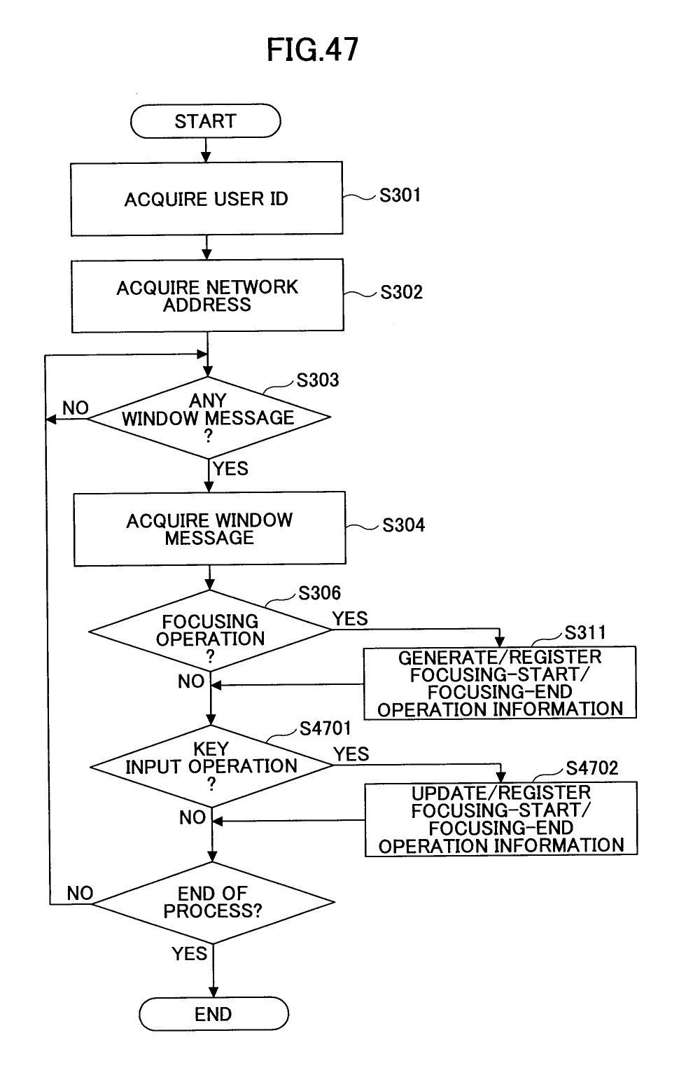

FIG. 47 is a flowchart showing a process of acquiring the document operation event information executed by the document operation event acquiring section 4401.

In the flowchart, it is determined whether the focusing-start/focusing-end operation is performed (step S306) and the document operation event information related to the focusing-start/focusing-end operation is acquired (step S311). Then it is determined whether a key input operation is performed on the focus-started document (document currently operated by the user) (step S4701). When it is determined that the key input operation is performed (YES in step S4701), a key input times of the document operation event information related to the focus-start/focus-end operation acquired in the step S311 is incremented by 1 to be updated (step S4702). When the key input is performed on the focus-started document (for example, an operation target document is switched or closed), the key input times of the document operation event information related to the focus-start/focus-end operation acquired in the step S311 is updated and transmitted to the document operation event information managing section 5601 of the server 20 so as to be registered. It should be noted that, when the document operation event information related to the focusing-start/focusing-end operation is transmitted to document operation event information managing section of the server to be registered, the update of the key input times may be performed by updating the document operation event information.

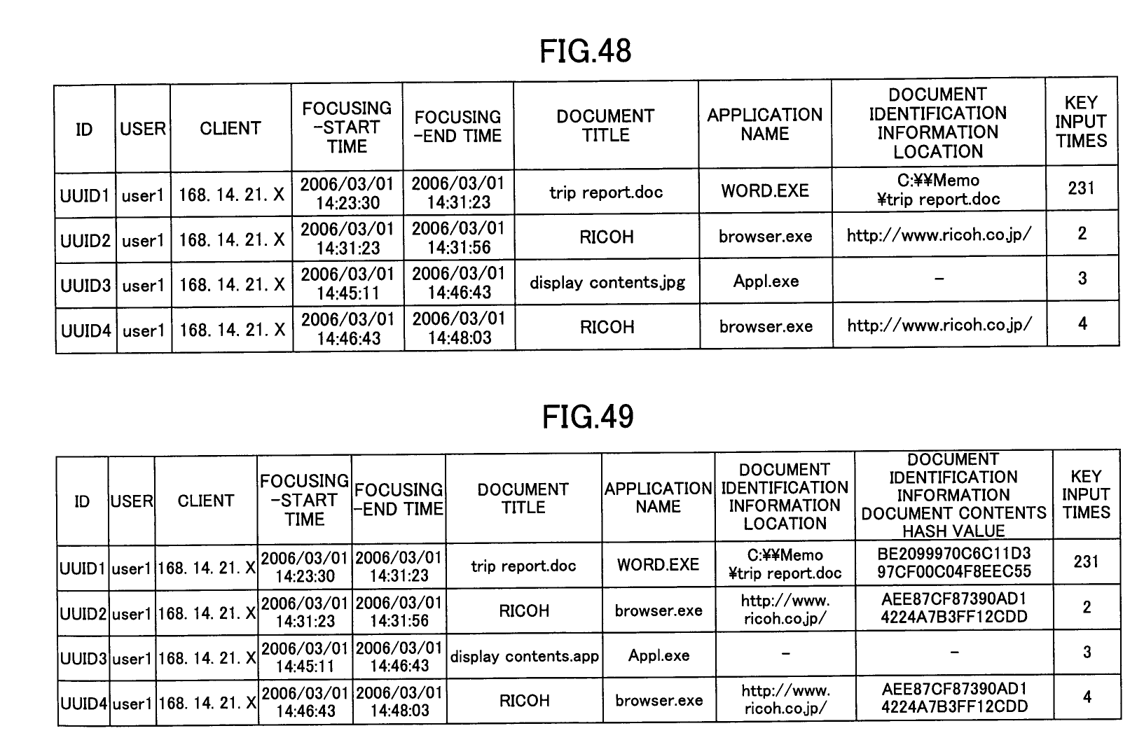

FIGS. 48 and 49 show exemplary information samples of the document operation event information managed by the document operation event information managing section 4501. In this embodiment, the key input operation is treated as one item of the focusing-start/focusing-end operation information. As described above, when the key input operation is performed on an operation target document, the key input times of the document operation event information related to the focus-start/focus-end operation is incremented by 1 and registered in the server. The document operation information managing section of the server searches for the corresponding focusing-start/focusing-end operation information and updates.

### [Schedule Information Managing Section]

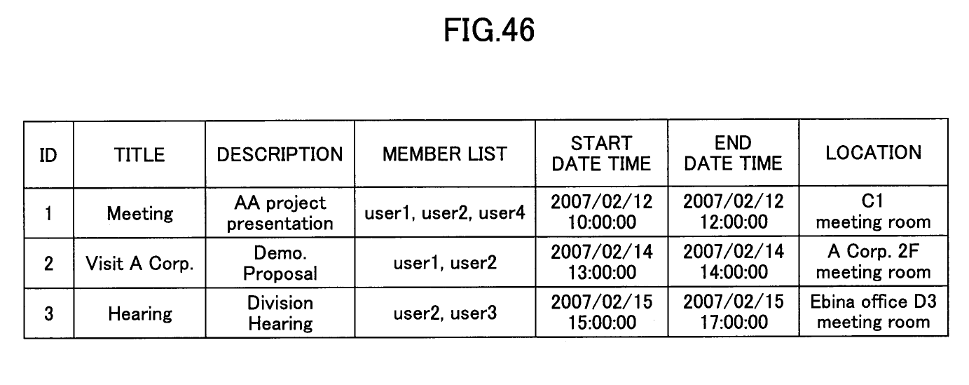

A schedule information managing section 4502 manages the user's schedule information. In this embodiment, it is assumed that task ID, task title, task description, task member user ID list, task start date and time, task end date and time, location, and related document identifier list are held as the items of the task information. FIG. 46 shows examples of schedule information.

### [Schedule Related Document Presenting Section]

Next, a schedule related document presentation process executed by a schedule related document presenting section 4402 is described.

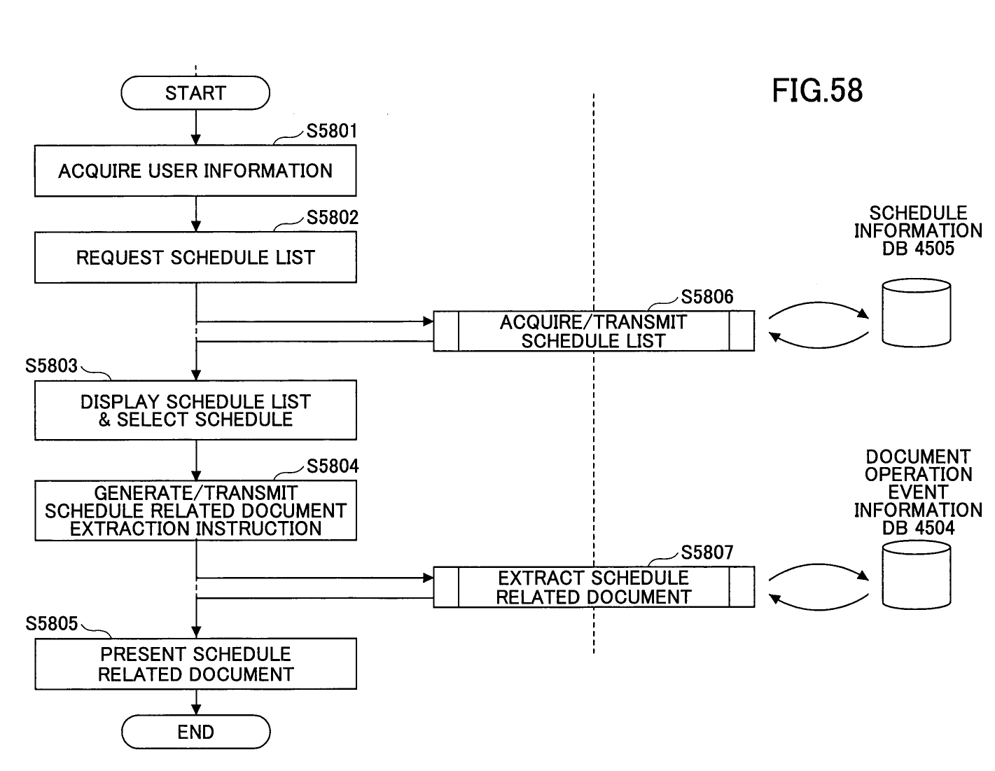

The schedule related document presentation process executed by the schedule related document presenting section 4402 is described with reference to FIG. 58.

The schedule related document presenting section 4402 acquires the user information (step S5801). Here, the user name as the user information to specify the user is acquired.

Next, the schedule related document presenting section 4402 transmits a schedule list display request including the acquired user information to the schedule managing section 4502 (step S5802).

Next, the schedule related document presenting section 4402 receives the schedule list from the schedule managing section 4502 as the response to the schedule list display request transmitted in step S5802 and displays the schedule list through the input/output section (step S5803).

Next, the schedule related document presenting section 4402 receives the schedule designated by the user from the schedule list displayed in step S5803, acquires the schedule ID (schedule related information) that is the identifier to uniquely determine the schedule from the schedule list, generates the schedule related document extraction instruction including the schedule ID, and transmits the schedule related document extraction instruction to the schedule related document extracting section 5503 (step S5804).

Next, the schedule related document presenting section 4402 receives the schedule related document extraction result from the schedule related document extracting section 5503 as the response to the schedule related document extraction instruction transmitted in step S5804, and displays the result to the user through the input/output section (step S5805).

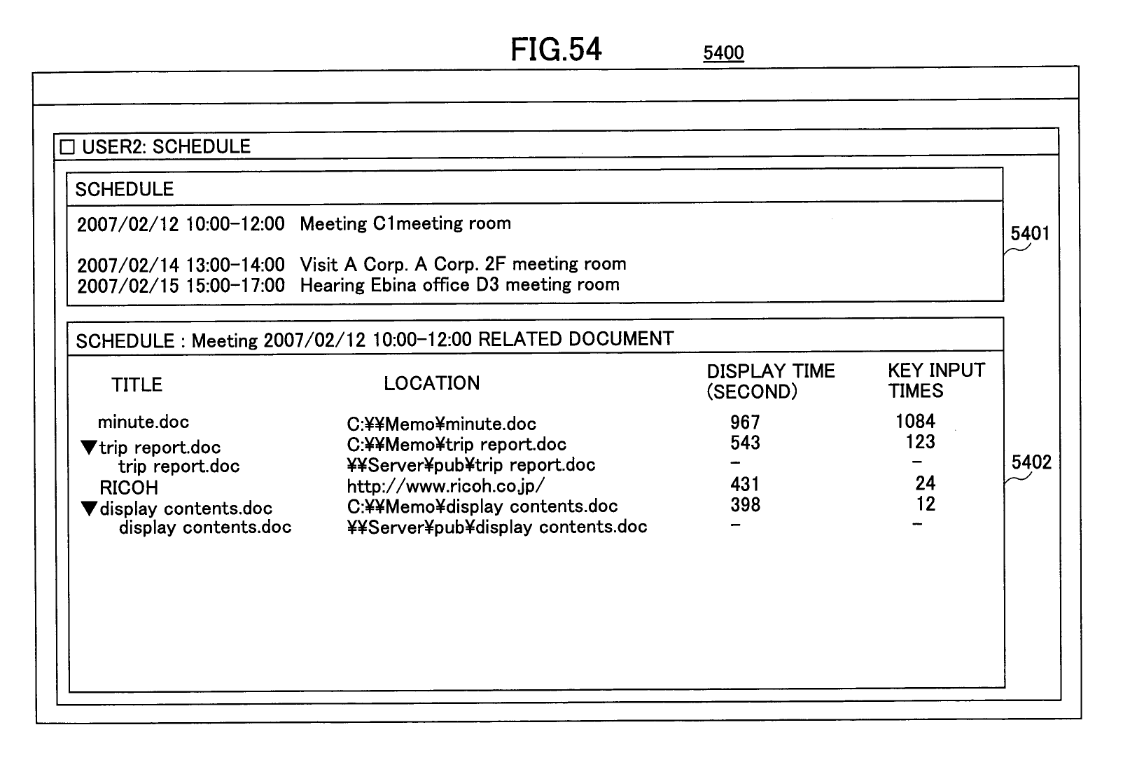

FIG. 54 shows a presentation example 5400 of the schedule related document shown to a user in step S5805. FIG. 54 shows an example when “user2” (user name) is using the client and an area (schedule list display area) 5401 displaying the schedule list of the user2 as the schedule and an area (schedule related document display area) 5402 displaying the related document of the schedule designated by the user from the schedule list are displayed. In the example shown in FIG. 54, a “▾” mark is added to the head of the document that has the other document having the same contents. By clicking at the “▾” mark, the document having the same contents can be selected to be displayed or deleted. When the displayed document has the acquired document location information and is accessible, the document can be open by selecting the document.

### [Schedule Related Document Extraction]

Next, a schedule related document extraction process executed by the schedule related document extracting section 4503 is described. The schedule related document extracting section 4503 extracts the schedule related document related to the schedule base on the schedule information and the document operation event information. The schedule related document extracting section 4503 of the server extracts the schedule related document based on the schedule related document extraction instruction transmitted from the schedule information presenting section 4402 of the client and returns the schedule related document to the client as the search result. In the following, since the schedule related document extraction process differs depending on whether the document identification information includes the document contents hash value, both cases are described separately.

### (When No Document Contents Hash Value is Used)

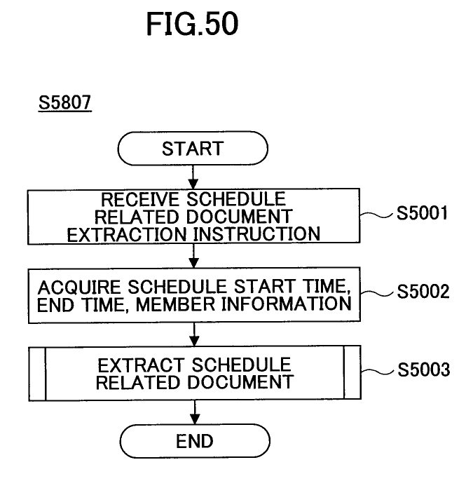

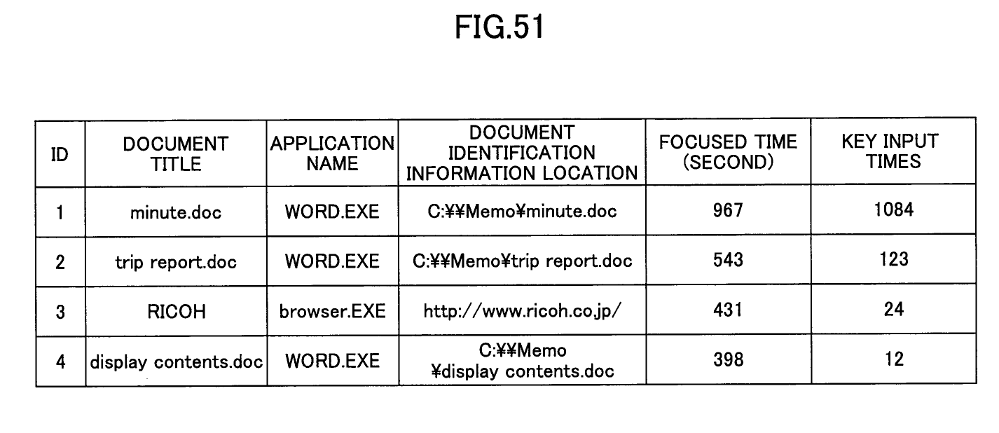

FIG. 50 is a flowchart showing a process of extracting the schedule related document executed by the schedule related document extracting section 4503 when no document contents hash value is used.

The schedule related document extracting section 4503 receives the schedule related document extraction instruction from the schedule related document presenting section 4402 (step S5001).

The schedule related document extracting section 4503 acquires the schedule start time, the schedule end time, and the member information as the schedule related document extraction information from the schedule management DB based on the schedule ID included in the schedule related document extraction instruction acquired in step S5001 (step S5002).

Next, the schedule related document extracting section 4503 extracts the schedule related document from the document operation event information DB based on the schedule related document extraction information acquired in step S5002 (step S5003).

Next, the schedule related document extraction process executed by the schedule related document extracting section 4503 (step S5003) is described.

The schedule related document extracting section 4503 extracts the record of document operation event having the same user name included in the member information based on the member information included in the schedule related document extraction information from the document operation event information DB (step S50031).

Next, the schedule related document extracting section 4503 extracts the document on which the focusing-start/focusing-end operation is performed during the period between the schedule start time and the schedule end time included in the schedule related document extraction information (step S50032). The document extracted in this step corresponds to the schedule related document. FIG. 30 shows a flowchart showing a process of extracting the schedule related document. By performing the processes, all documents related to the schedule can be extracted because not only the document operation event information of the user issuing the schedule related document extraction instruction but also the document operation event information of other members sharing the same schedule is used.

The schedule related document extracting section 4503 transmits the schedule related document extracted in step S5003 to the schedule related document presenting section 4402, and this process is ended.

### (When a Document Contents Hash Value is Used)

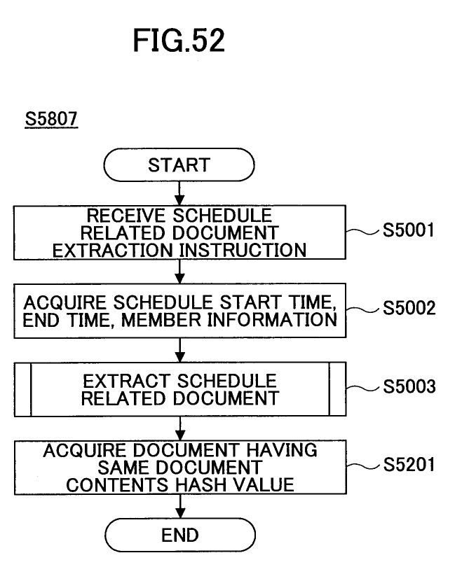

Next, a process of extracting the schedule related document executed by the schedule related document extracting section 4503 when a document contents hash value is used is described with reference to FIG. 52.

The schedule related document extracting section 4503 receives the schedule related document extraction instruction from the schedule related document presenting section 4402 (step S5001).

The schedule related document extracting section 4503 acquires the schedule start time, the schedule end time, and the member information as the schedule related document extraction information from the schedule management DB based on the schedule ID included in the schedule related document extraction instruction acquired in step S5001 (step S5002).

Next, the schedule related document extracting section 4503 extracts the schedule related document from the document operation event information DB based on the schedule related document extraction information acquired in step S5002 (step S5003).

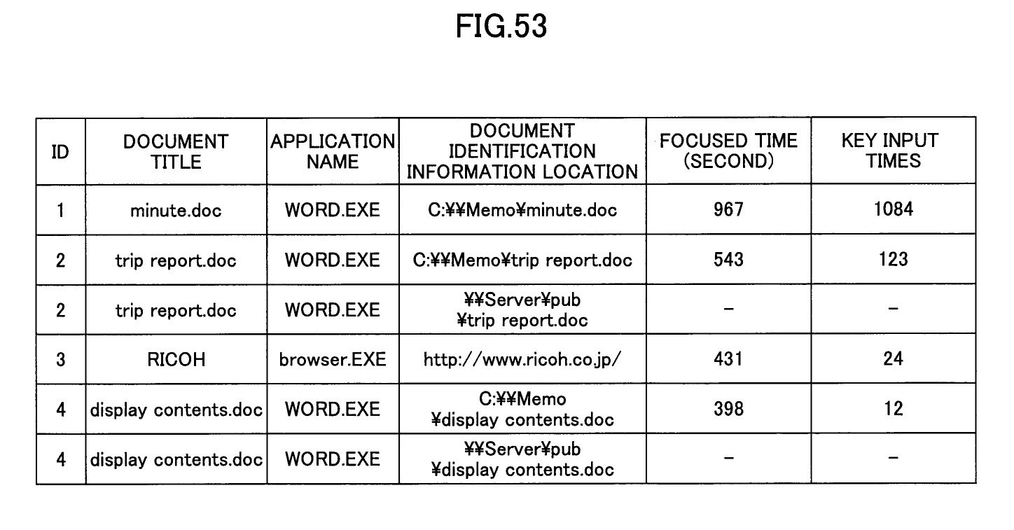

Next, the schedule related document extracting section 4503 acquires the document contents hash value of the document operation event information of the schedule related document extracted in step S5003 and then acquires the document operation event information having the same document contents hash value to acquire the same document contents information (step S5201). The acquired same document contents information is exemplified in FIG. 53. In the examples of FIG. 53, there are some documents having the same ID. The documents having the same ID have the same document contents hash value. There are documents having the same ID, ID2 or ID4. The documents having the same document contents information are assumed to be the schedule related documents.

The schedule related document extracting section 4503 transmits the schedule related document extracted in step S5003 to the schedule related document presenting section 4402, and this process is ended.

As described above, according to the fourth embodiment of the present invention, since the related document is extracted using the time information of the schedule and the time information of the document operation event information, the related document related to the schedule based on the user's schedule can be directly extracted and displayed. More specifically, for example, the document used in a “meeting on August 31^{st}” can be directly extracted and displayed from the schedule information of, for example, “August 31^{st}:meeting”.

Further, since the key input is added as a item of the document operation event information, the user can check the key input times of the displayed schedule related document and can select a document based on the key input times of the documents during the schedule of the key document.

The present invention is not limited to the above-mentioned embodiments, and variations and modifications may be made without departing from the scope of the present invention.

The present application is based on and claims the benefit of priority of Japanese Patent Application No. 2006-252623, filed on Sep. 19, 2006 the entire contents of which are hereby incorporated by reference.

What is claimed is:

1. An information processing apparatus comprising:
a document operation event acquiring unit acquiring the document operation event information representing the information related to an event of a document operation performed by a user on a computer;
a document operation event managing unit managing the document operation event information acquired by the document operation event acquiring unit; and
a related document extracting unit extracting a related document of a designated document based on the document operation event information managed by the document operation event managing unit.

2. An information processing apparatus comprising:
a task information managing unit managing task information representing the information related to a user's task;
a document operation event acquiring unit acquiring the document operation event information representing the information related to an event of a document operation performed by a user on a computer;
a document operation event managing unit managing the document operation event information acquired by the document operation event acquiring unit; and
a task related document extracting unit extracting a related document of a designated task based on the task information managed by the task information managing unit and the document operation event information managed by the document operation event managing unit.

3. The information processing apparatus according to claim 2, wherein:
when task related document information is managed by the task information managing unit, the task related document extracting unit extracts a related document of a designated task based on the task related document information and the document operation event information.

4. The information processing apparatus according to claim 1, further comprising:
a document operation event designating unit designating a document operation event used when a related document is extracted by the related document extracting unit.

5. The information processing apparatus according to claim 2, further comprising:
a document operation event designating unit designating a document operation event used when a related document is extracted by the task related document extracting unit.

6. The information processing apparatus according to claim 1, further comprising:
a user designating unit designating a user, wherein:
the related document extracting unit extracts a related document of a designated document based on the document operation event information of the user designated by the user designating unit from among the document operation event information managed by the document operation event managing unit.

7. The information processing apparatus according to claim 2, further comprising:
a user designating unit designating a user, wherein:
the task related document extracting unit extracts a task related document of a designated task based on the task information managed by the task information managing unit and the document operation event information of the user designated by the user designating unit from among the document operation event information managed by the document operation event managing unit.

8. The information processing apparatus according to claim 1, wherein:
the document operation event acquiring unit acquires at least one piece of information selected from the group consisting of the information of opening/closing document, the information of focusing document, and the information of copying/pasting document as the document operation event information.

9. An information processing method comprising:
a document operation event acquiring step of acquiring the document operation event information representing the information related to an event of a document operation performed by a user on a computer;
a document operation event managing step of managing the document operation event information acquired in the document operation event acquiring step; and
a related document extracting step of extracting a related document of a designated document based on the document operation event information managed in the document operation event managing step.

10. An information processing method comprising:
a task information managing step of managing task information representing the information related to a user's task;
a document operation event acquiring step of acquiring the document operation event information representing the information related to an event of a document operation performed by a user on a computer;
a document operation event managing step of managing the document operation event information acquired in the document operation event acquiring step; and
a task related document extracting step of extracting a related document of a designated task based on the task information managed in the task information managing step and the document operation event information managed in the document operation event managing step.

11. A program causing a computer to perform each step of the information processing method according to claim 9.

12. A computer-readable recording medium storing the program according to claim 11.
